(19) United States
(12) Patent Application Publication
(10) Pub. No.: US 2012/0228947 A1
(43) Pub. Date: Sep. 13, 2012

(54) ENERGY COLLECTION SYSTEM AND METHOD

(76) Inventor: Noam Kornblitt Noy, Netanya (IL)

(21) Appl. No.: 13/503,665

(22) PCT Filed: Oct. 28, 2010
(86) PCT No.: PCT/IL2010/000891

§ 371 Date: Jun. 3, 2012

Related U.S. Application Data
(60) Provisional application No. 61/255,973, filed on Oct. 29, 2009.

(51) Int. Cl. H02J 1/00

(52) U.S. Cl. 307/80

(57) ABSTRACT

A system and method is provided for optimizing energy collection from a plurality of energy generators, which have different IV-characteristics thus defining over-performing and under-performing energy generators. Optimization of the energy collection is implemented by providing a power redistribution unit electrically connected to the plurality of electrically connected energy generators. The power redistribution unit comprises a bus-connector and at least two electric coupling assemblies electrically connectable to the bus-connector. Each of the electric coupling assemblies is associated with one or more of the energy generators and is configured and controllably operable to provide selective electrical coupling between the bus-connector and said at least two of the energy generators according to a predetermined time pattern such that during the system operation there always exist at least one coupling assembly in the electrical connection to the respective one or more of the energy generators, thereby enabling redistribution of power in between said at least two energy generators and optimizing energy collection therefrom.

### FIELD OF THE INVENTION

This invention relates to energy collection from an array of power generators having varying power yield. In particular, the invention is highly adapted for use with a photovoltaic system or battery pack for optimizing a manner in which the power, generated by multiple photovoltaic cells or battery cells is harvested.

### BACKGROUND OF THE INVENTION

Many electric energy production techniques (energy generation/conversion techniques) utilize energy generation modules including multiplicity of electric energy producing cells connected to each other in series and/or in parallel connections. Generally, the operation of the cell is in accordance with a Current-Voltage curve (i.e. I-V curve) characteristic of the cell. The I-V curve characterizes the operation of the energy producing cell for a given cell (for example, in case of a photovoltaic cell, defined by the cell's dimensions and materials, e.g. single- /poly-crystalline silicon, amorphous silicon, CDTE and other materials) and for certain operation conditions of the cell, e.g. determined by the operational temperature of a photovoltaic cell (which might affect its efficiency) and the amount of input energy to be converted by the cell to electric energy.

A multitude of energy producing cells connected in series to one another, generally termed a cell string or string, provides electric output having certain electric current which equally flows within all the cells of the string. The output voltage of such string is the sum of voltages, generated by each of the cells in accordance with the corresponding I-V curves of the cells and with said certain electric current which flows through the cells of the string. In other words, each cell is constrained to operate at a certain fixed point along its I-V curve which is determined in accordance with the value of said certain current. Said certain current is, in turn, dependent on the electric load on the entire cell string.

Typical energy generation module includes an arrangement of multiple cell strings arranged in parallel electrical connection with respect to one another such that the output currents from the so-connected cell strings are accumulated.

FIG. 1 illustrates schematically the known “central inverter” configuration of a solar power system (module) 100. The system 100 includes two cell strings 107a and 107b including respectively multitude of photovoltaic cells also referred to herein as solar panels 101 electrically connected in series to each other. The number of cells 101 in each string (107a, 107b) is designed to provide sufficiently high output voltage from each of the strings (107a, 107b). This is because efficient conversion from the DC electricity produced by the cells (101) into typical standard network AC voltages (e.g. of about 100V, 120V, 240V or 480V AC) requires relatively high input DC voltage (about several hundreds of volts DC should be provided as input to the inverter). Typical cell strings include multiple solar panels, and the number and type(s) of which are selected such as to provide high DC output voltage from the string (of about 400 or 600 volt). The cell strings 107a and 107b are electrically connected, in parallel forming a parallel arrangement 107 having output electrical current being the total electric current from the strings. The number of strings in such arrangement is dictated by the required current output from the solar power system 100.

Such energy generation module 100 has a corresponding I-V curve associated with the IV curves of all the cell strings in the module, while the I-V curve of a string is associated with the I-V curves of the individual cells and with the nature of the electric connection between the cells of the strings. In such a module, due to the parallel connection between the cell strings, the cell strings are forced to operate with a similar output voltage. Ideally the maximal power (energy) is collected from the multiple cells when all the cells operate at its maximal power point. In accordance with the “central inverter” architecture, the arrangement 107 of strings is connected to a DC to AC inverter 103 through a Maximal Power Point Tracker (MPPT) 105 unit. The latter is aimed at maximizing the total output power from the module. Typically, a single MPPT unit is used to maximize the energy yield from the entire module by controlling a point (operational point), at which the module operates along its I-V curve by controlling the load (resistance) on the strings and thus controlling their common output voltage and the total output current therethrough.

The output voltage of each string is a sum of the output voltages of the cells of the string. Each of the cells in the string is associated with a bypass diode 109 which enables current along the string to bypass the cell associated therewith. This allows operation of the string even if at least one of its cells malfunctions (e.g. cells having high resistance or cells which operate under shaded light conditions and thus are incapable of providing the required current). The bypass diodes actually operate to totally neutralize malfunctioning or “weak” cells (which cannot produce the current value that flows along the string). In order to avoid back current flow when parallel connected strings produce different voltages, each string is associated with a blocking diode 106 at the end of every serial string. MPPT 105 operates to choose an UV operation point of the parallel arrangement 107 which produces maximum DC power.

MPPT units may be associated with individual cells and/or individual strings (rather than using a single MPPT for all the strings as described above). For example, US Patent Publication 2008/0143188 discloses a system and method for combining power from DC power sources using MPPT units associated with the power sources respectively. In this system, each power source is coupled to a converter. Each converter converts input power to output power by monitoring and maintaining the input power at a maximum power point. Substantially all input power is converted to the output power, and the controlling is performed by allowing output voltage of the converter to vary. The converters are coupled in series. An inverter is connected in parallel with the series connection of the converters and inverts a DC input to the converters into an AC output.

The inverter maintains the voltage at the inverter input at a desirable voltage by varying the amount of the current drawn from the converters. The current and the output power of the converters, determine the output voltage at each converter.

### GENERAL DESCRIPTION

There is a need in the art for an effective energy collection from multiple power generators having varying power yield (having different I-V curves). The present invention solves this need by providing a novel energy collection system and a method for use with energy generating system formed by multiple power generators, which are unavoidably “non-identical” with regard to their I-V curves. In particular, the invention can be used with a photovoltaic systems or battery packs for optimizing a manner in which the power, generated by multiple photovoltaic cells or a multiple cells battery pack, is read out (collected) from the system, and is therefore described below with reference to this specific application. It should however be understood that the invention is not limited to this application, and any other suitable power generator may be considered such as for example batteries.

The problems with the existing approach of energy collection from multiple photovoltaic cells are associated with the following: As described above, the power generators (cells) are typically electrically connected between them forming one or more multi-cell strings. It is known to utilize MPPT(s) unit(s) to maximize in a controllable manner the output power from the multi-cell or multi-string power generation system. This approach however suffers from a need for controlling the process of power optimization and also suffer from the following drawbacks.

The use of a single MPPT (see FIG. 1) for optimizing the operation and power yield from the multi-cell module is typically associated with certain un-gained energy which is not extracted. This is mainly because each of the cell-strings is typically associated with an I-V curve different from the I-V curve of the rest of the cell strings, and is, thus, associated with a different maximum power point in terms of its optimal voltage output value. As the cell strings are connected in parallel to each other, they are constrained to operate with the same output voltage which is not necessarily equal to optimal voltages of the individual strings (at which maximal power is obtained from the strings).

Utilizing string-dedicated MPPT modules enables to operate each of the strings at its individual maximum power point associated with the particular I-V curve of the string. However, also in such a configuration, there is still a great deal of ungained or lost energy. This is mainly because each cell in the string has generally different I-V curve. Accordingly, utilizing string-dedicated MPPT still does not provide the cells' operation at their MPPs (of their individual I-V curves) because the cells are constrained to operate with an equal electric current commonly flowing through the respective string.

As for the use of cell-dedicated MPPTs (i.e. including configuration of dedicated MPPTs per cell groups (arrays) such as solar panels or battery packs), this requires the use of dedicated voltage converters. The latter however suffers form low efficiency, especially when dealing with low voltages.

Thus, the existing approach for the energy harvesting from multiple energy generators (cells) suffers from the fact that the arrangement (electrical inter-connection) of multiple energy producing cells constraints the cells to operate with a common output voltage or with common output current. Accordingly, most of the individual cells do not operate at their MP point and the efficiency of the entire multi-cell power system is low.

The present invention is based on the understanding that the full potential performance of a multi-cell photovoltaic panel (constituting an array of electric energy generators) is practically not realized because the common method of connecting the cells in a combination of series and parallel configurations results in that the cells with poorest performance degrade the performance of “better” cells. The same occurs when connecting such multi-cell panels between them.

Existing photovoltaic systems make it very difficult to compensate for variations in photovoltaic cells and thus in multi-cell panels. Additional complexity and expense is added to such systems if all of the cells cannot be oriented in the same direction with respect to incident light. Also, for example, when the shade from an object crosses a cell, or portion of a cell or several cells (panel), the power degradation that occurs in the cell or cells does not only reduce the performance of the cell(s) due to the shading effect, but the shaded cell (panel) also consumes power from other non-shaded cells (panels) or impedes power from being delivered to the system from other non-shaded cells (panels).

In existing photovoltaic systems, an MPPT unit is typically connected to and affects the total multi-cell structure, rather than each cell/panel individually. Maximum power from the sum of the total arrangement of connected cells in the structure is less than the sum of each cell's maximum power produced separately and then summed with that of other cells in the system. This discrepancy in total power is due to the fact that in practice it is very difficult to find all cells in any system with exactly identical characteristics (I-V curves), and as a result when all the cells are coupled together, the poorly performing cells degrade the performance of the well performing cells. Manufacturing tolerances for photovoltaic multi-cell panels are typically 5 to 10 percent.

Thus, in existing photovoltaic systems, there is a need to match the characteristics of the cells to each other for optimal performance of the system. Matching photovoltaic panel characteristics makes it very hard to add a cell on to the system or replace damaged cells/panels at a later time. Assuming one of the cells in a photovoltaic system is damaged and needs to be replaced and for example such cell is not available at the market any more, in this case a different cell is to be used, with different characteristics, such as I-V curve. Such matching of an individual cell is very difficult to design. The present invention allows for cells with different characteristics, e.g. different I-V curves, to perform together and to obtain high efficiency power point of the entire system.

The known techniques aimed at solving the above problems of the existing systems utilize a combination of an MPPT unit and a DC to DC converter unit per panel, together with a central control unit (see for example US Patent Publication 2008/0143188). In such systems all energy produced by the solar panel is converted to DC current at a different voltage in a way that all outputs will provide the same current in case of serial connection or the same voltage in case of parallel connection. With such configuration, however, the efficiency of the system is still limited, mainly because DC to DC conversion is practically not 100% efficient. Converting all the power produced by the cell will therefore cause large power losses. Also, installing an additional active device, such as MPPT or DC to DC convertor, across the power pass increases the chances of system failure (due to the specific device failures), and thus the overall system

Mean Time Between Failures is reduced. Also, MPPTs and DC to DC converters for such high energy systems are costly devices that add to the overall solar installation complexity and cost.

The present invention provides a novel approach for solving the above described problems of energy generation system, such as photovoltaic system. The invention utilizes a power distribution unit connecting a plurality of energy generators (e.g. solar cells, batteries etc.) to each other. The energy distribution unit equalizes the voltage on each of the energy generators connected in series, such that the voltage on the high-performing energy generators (cells) is reduced and the voltage on the low-performing cells is increased. Basically, according to the invention, the performances of all the cells in a string are equalized to that of a so-called “virtually average cell” of the string. This is achieved by connecting each cell to a group of other cells in the cell array via a common bus line thereby causing simultaneous self distribution of the energy produced by all the cells in between said cells. The energy distribution between the cells is based on potential (voltage) equilibration between connected high-voltage and low-voltage junctions. Such potential equilibration occurs spontaneously and does not require any management thereof and thus any specific control unit.

Thus according to one broad aspect of the invention, there is provided an electronic system for energy collection from a plurality of electrically connected energy generators each having a respective current-voltage characteristic, said electronic system comprising a power redistribution unit electrically connected to said plurality of electrically connected energy generators, the power redistribution unit comprising a bus-connector and at least two electric coupling assemblies electrically connectable to the bus-connector, each of the electric coupling assemblies being associated with one or more of the energy generators and being configured and controllably operable to provide selective electrical coupling between the bus-connector and said at least two of the energy generators thereby enabling redistribution of power in between said at least two energy generators and optimizing energy collection therefrom.

The electric coupling assemblies are preferably configured and operable according to a predetermined time pattern.

In some embodiments the time pattern is selected such that during the system operation there always exists at least one coupling assembly in electrical connection to the respective one or more of the energy generators. In some embodiments, the time pattern may be such that during the system operation there always exists at least one coupling assembly in electrical connection with the bus line.

The electric coupling assembly may include at least one coupler. The coupler comprises an energy storage unit for storing electrical energy configured for electrical connection with the respective energy generator, and a switch assembly. The switch assembly is successively operable in first and second operative modes. When in the first operative mode the switch assembly provides electrical connection of the corresponding one of the storage unit and the respective energy generator, and when in the second operative mode it provides connection between the storage unit and the bus-connector thereby performing redistribution of power in between said at least some of the energy generators.

The electric power redistribution unit may be configured to provide parallel connection between at least some of the storage units via the bus-connector. This enables redistribution of power in between the storage units while electrically connected to the bus.

In some embodiments of the invention, the storage unit comprises at least one charge storage device.

The switch assembly may be configured and operable to exclusive parallel connection of the respective storage unit with either the corresponding energy generator or with the bus-connector.

In some embodiments of the invention, the electric coupling assembly is configured such that at least two of the couplers are associated with the common one of the energy generators. In this case, during the system operation, at least one of the couplers is in an operational condition thereof corresponding to the first operative mode of the switching assembly; or alternatively, at least one of the couplers is in an operational condition corresponding to the second operative mode of the switching assembly.

The system may be associated with (i.e. connectable to or including as a constructional part thereof) a synchronizing unit configured and operable to perform the successive operation of the switch assembly in the first and second modes. The synchronizing unit may include a plurality of synchronizers, each connected to one or more of the couplers associated with the respective energy generator.

In some embodiments of the invention, the power storage unit comprises two or more charge storage devices, and the switch assembly is configured for selectively implementing either parallel or serial connection between the charge storage devices. By this, an electric potential on the power storage unit can be controlled.

The power redistribution unit may be configured and operable to ensure that the electrical parameter of each energy generator (which is associated with respective storage unit(s)) approaches an average value of said parameter of all energy generators. The electrical parameter includes at least one of electric power, electric current and voltage. The power storage unit may comprise at least two capacitors, and be selectively shift able between different electrical conditions corresponding to different electrical connections between the capacitors, resulting in different effective capacitance of the power storage unit. As a result, variation of output voltage of the power storage unit is provided, providing for redistributing the electric current between the energy generators. The power storage unit may comprise an additional switching assembly configured and operable to implement the selective shifting of the power storage unit between its different electrical conditions characterized by different capacitance respectively. For example, each of the couplers of the electric coupling assembly may be associated with a synchronization unit configured and operable to perform the selective shifting of the power storage unit between its different electrical conditions synchrony with switching between the first and second operative modes of the respective switching assembly.

According to another broad aspect of the invention, there is provided an energy generating system comprising: an array of electrically connected energy generators each having a respective current-voltage characteristic; an energy collection system for collecting energy from said array of electrically connected energy generators. The energy collection system comprises: an array of storage units for electrical connection with the array of the energy generators respectively for storing electric power generated by said energy generators; a bus-connector connectable to the array of the power storage units; and an array of switch assemblies, each controllably successively operable in a first operative mode and a second operative mode, such that the switch assembly when in the first operative mode provides electrical connection of the corresponding one of the power storage units and the respective energy generator, and when in the second operative mode provides connection between the electric power storage unit and the bus-connector thereby performing power redistribution in between the energy generators.

According to yet another broad aspect of the invention, there is provided an electric coupling assembly for use in energy collection from a plurality of electrically connected energy generators, each energy generator having a respective current-voltage characteristic, said electric coupling assembly comprising a plurality of couplers associated with the plurality of energy generators, respectively, each coupler comprising: a power storage unit for electrical connection with the respective energy generator and for storing electric power generated by the energy generators; and a switch assembly successively operable in first and second operative modes, the switch assembly when in the first operative mode providing electrical connection of the corresponding one of the power storage units and the respective energy generator, and when in the second operative mode providing connection between the power storage unit and an external, common for all energy generators, bus-connector, said coupler assembly thereby performing redistribution of power in between the energy generators.

According to yet further aspect of the invention, there is provided a method for optimizing energy collection from a plurality of energy generators electrically connected in series, said energy generators having different IV-characteristics defining over-performing and under-performing energy generators, the method comprising operating, with a predetermined time pattern, electrical connection in parallel of all of said energy generators to a common bus-connector, thereby causing redistribution of energy between said energy generators by equalizing energy between the energy generators resulting in transfer of energy from over-performing to under-performing energy generators.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration of the conventional central inverter configuration of a solar power system;

FIG. 2 schematically illustrates the principles underlying the invention, for power redistribution between underperforming and over performing energy generators;

FIG. 3 illustrates, by way of a block diagram, an embodiment of an electric energy production system utilizing an electronic system according to the invention for energy collection from a plurality of energy generators;

FIGS. 4A to 4D illustrate an exemplary configuration of the energy collection system of the invention, where FIG. 4A shows the general illustration of the energy generation system, FIG. 4B illustrates an example of the configuration of a coupling assembly suitable for use in the system of FIG. 4A, FIG. 4C shows an example of coupler for use in the coupling assembly, and FIG. 4D illustrates the operation of a local controller associated with the coupler;

FIG. 5A to 5D illustrate schematically an example of the configuration of a power storage unit suitable for use in the coupler;

FIG. 6A illustrates an embodiment of the present invention configured for providing continuous power optimization to the cells in the string by utilizing at least two power redistribution modules;

FIGS. 6B and 6C illustrate another embodiments of the invention, where a single power redistribution module is configured for providing continuous power optimization to the cells in the cell string;

FIGS. 7A to 7C exemplify another embodiment of the invention, where the power redistribution system is designed to handle long string with high voltage end to end using standard 100 volt fast FET switches;

FIGS. 8A and 8B illustrate an energy generation system utilizing the principles of the present invention designed to create a voltage gap between the local side of a coupler in the coupling assembly and the respective solar cell output that should be optimized; and

FIGS. 9A and 9B exemplify an energy generation system of the invention configured with multiple strings architecture.

### DETAILED DESCRIPTION OF EXEMPLARY EMBODIMENTS

The present invention is aimed at improving the performance of an energy generation system formed by one or more arrays/strings of energy generators. More specifically, the present invention is used for improving the efficiency of energy harvesting from photovoltaic strings/arrays and is therefore described below with respect to this specific but not limiting application.

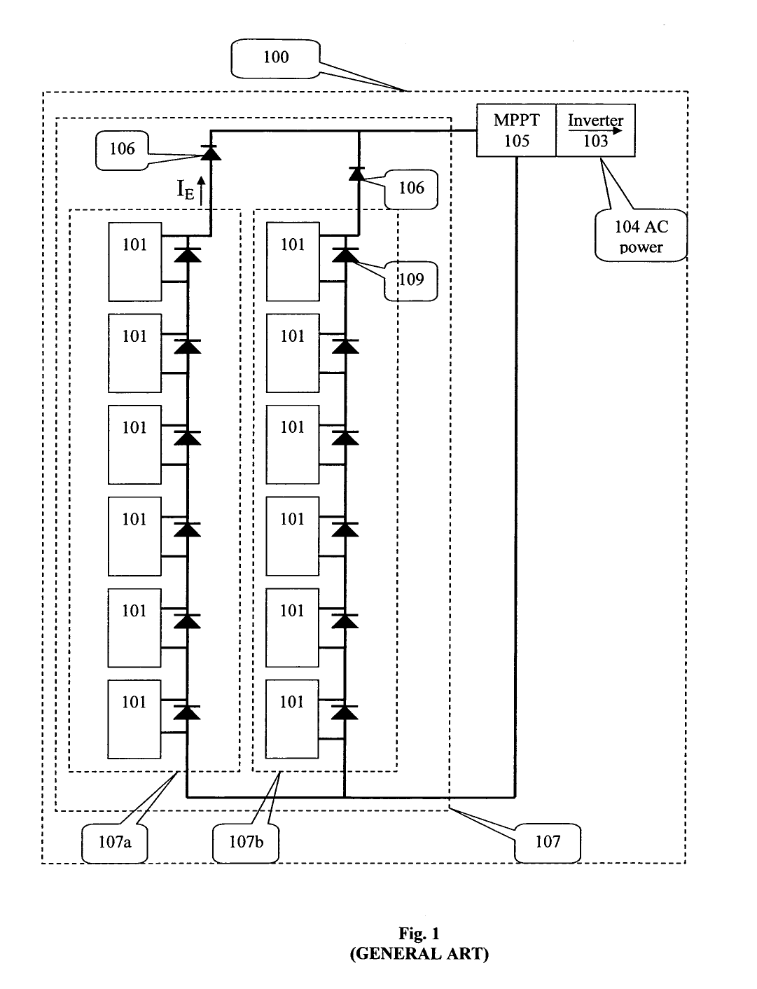

FIG. 1 shows schematically one of the known configurations for a multi-cell/multi-panel solar power system. This system utilizes the cells/panels arranged in multiple strings, where the cells of the string are connected in series. The system also utilizes an MPPT unit common for all the strings.

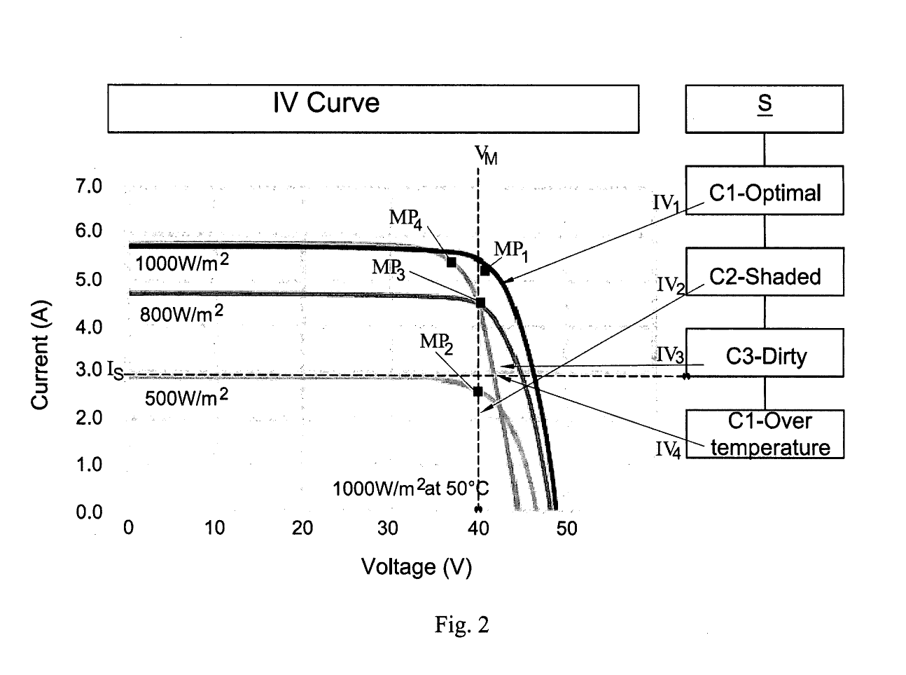

Referring to FIG. 2 there is schematically illustrated the principles underlying the invention. Here, a typical serial string S is shown that includes four solar cells C1-C4 (constituting electrical energy generators) of the same type and size operating under different conditions (e.g. exposed to different environmental conditions). Cell C1 operates under optimal conditions in terms of lighting and operational temperature. Cells C2 and C3 are under-performing cells due to their operation at poor lighting conditions, namely shaded light condition and poor light collection due to dirt on the cell surface. Cell C4, is exposed to full lightning conditions, but is also under-performing due to relatively high operational temperature. The resulted I-V curves IV₁-IV₄ corresponding respectively to the operation of the four solar cells C₁-C₄ are graphically illustrated. In the I-V curves IV₁-IV₃ corresponding to cells C₁-C₃, the major effect of the different lightning conditions is on the maximal obtainable output currents from the cells, while the maximal obtainable voltages from the cells do not vary substantially. As for cell C4, its I-V curve IV₄ shows that the effect of the high temperature of the cell C4, during operation, is mainly expressed in reduction of the maximal obtainable voltage from the cell C4 while the maximal obtainable current remains similar to the maximal current that can be obtained from cell C1.

It should be noted that in case the power cells are batteries, different I-V curves and different maximum power points may result, for example, from different chemical degradations of the cells and different operational temperatures.

As also shown in the graphs, the I-V curves IV₁-IV₄ are characterized by the maximal power points MP₁-MP₄ of cells C₁-C₄. It is illustrated that while operating at their respective MP points, the effect of different lighting conditions on cells C₁-C₃ mainly affects the output currents from the cells while their output voltages are of somewhat similar values V_{M} at these point.

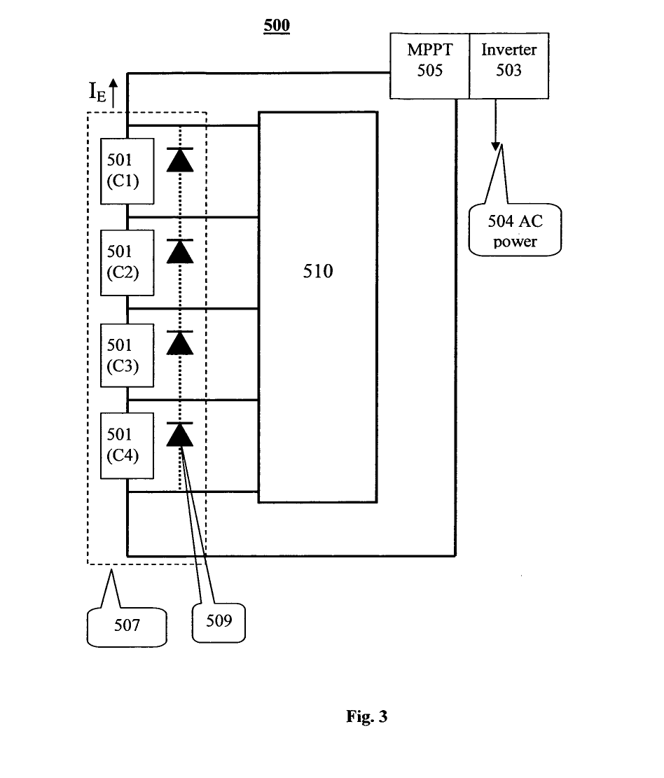

FIG. 3 is a block diagram illustrating an embodiment of an electric energy production system 500 utilizing a plurality of electrically connected energy generators, generally at 501 being different cells C1-C4 in the meaning that their current-voltage characteristic are different, and utilizing an electronic system 510 according to the invention for energy collection from the energy generators 501. The energy collection system 510 operates as a power redistributer configured and operable for providing self distribution of power/energy produced by all the cells 501 in between at least some of the cells, thus optimizing energy collection from at least some (generally at least two) of the energy generators 501.

In this example, the energy production system 500 is a solar power system and accordingly the energy generating (producing) cells 501 are solar cells or photovoltaic cells. It should be however understood that the present invention is not limited to the solar energy production and may be used for efficient harvesting of electric energy from various DC electric energy sources (DC Power Sources) such as batteries, dynamos etc. which might be characterized with I-V curves different from those of typical solar cells.

Generally, the electric energy production system 500 includes multiple cells 501 arranged in one or more cell strings 507 (only one such string is illustrated) which are electrically connected in parallel to each other to form a complete photovoltaic device. The cell string 507 includes multiple, serially connected, energy producing cells (solar cells/panels) 501. As for the power redistributer of the energy production system 500, it may include one or more power redistribution units 510 each associated with at least some of the cells in the string and configured and operable to enhance the energy production from the string 507 (or string part) by optimizing the power points at which the individual cells operate. The configuration and operation of the power redistribution unit 510 will be described further below.

Also typically provided in the electric power generation system 500 is a DC to AC inverter 503, which is connected to the array(s) (string(s)) of cells 507 via an MPPT-based controller 505, and providing AC output 504. As described above, the MPPT unit is configured and operable for optimizing the operational conditions of the cell strings connected thereto, by drawing the optimal current at the optimal voltage, in accordance with the total I-V curve of the cell strings. It should be understood that the invention utilizes the principles of MPPT (bring the string or strings to a common MPP, or Maximal Power Point) and provides appropriate energy redistribution between the cells/panels to bring every cell/panel to its own MPP, while keeping the entire string at its MPP. The inverter 503 operates to convert the DC electrical output of the cell strings into an AC electrical power of desirable voltage and frequency. It should be understood that the use of inverter 503 for power conversion is optional, and such inverter 503 may be replaced by other electrical converters such as DC to DC converters, in accordance with the required output from the system.

As also described above, the number and type of cells 501 may be selected such that a nominal output voltage of the string 507 is high enough to enable efficient DC to AC conversion, e.g. typical DC voltages might be in the range of 400 to 600 volts.

Optionally, in the energy generation system 500, the string 507 is associated with bypass diodes 509 arranged in parallel electrical connection with the respective cells 501. This enables the current through the string 507 to bypass any malfunctioning/defective solar cell, which provides robustness of the cell string 507 and enables it to function also when one or more cells do not operate properly. In the cell string that includes bypass diodes 509, the electric current through the string is allowed to bypass any malfunctioning or “weaker” (under performing) cells. In this regards, each of the cells in the string operates for producing the same current that flows along the string 507 and for generating voltage in accordance with the power point, along its I-V curve, corresponding to such current. In case the cell malfunctions or is substantially weaker than the other cells (e.g., a zero voltage is obtained at the power point, along its I-V curve, which corresponds to such current), the cell becomes inactive and the current along the string bypasses the cell through bypass diodes 509. In the absence of bypass diodes 509, such malfunctioning or weak cell impairs and stops the energy production from the whole string 507. The use of bypass diodes thus enables to improve the power production from the multi-cell string by enabling total neutralization of substantially weak cells, where the power gain from their operation is lower than the power gained by when these weak cells are neutralized and the current through the string increases. Actually, the choice between the two operation states of underperforming cells/panels 501 (e.g. working or disabled) is enabled by the bypass diodes 509 and is controlled by the string's MPPT (if such exists) or by the MPPT 505 of the entire system 500.

Power redistribution unit or module 510 of the present invention enables the string 507 to operate at higher energy production rate (higher Power Point or PP). As will be described more specifically further below, this is achieved by the configuration and operation of the module 510 as an energy (power) exchanger for all the cells 501, with which it is associated, automatically draining excess power from over performing cells for supplying power to the underperforming cells to compensate for their deficiencies in power production. As will be described further below, the power redistribution unit provides the system operation in two sequential modes. During one of these operation modes, the power redistribution unit performs collection of energy generated by a plurality of cells from said plurality of the cells, and during the other mode the power redistribution unit allows self distribution of the collected energy in between said cells thus bringing the cells to the optimal state with regard to power generation. These two operation modes are implemented in an alternating fashion while allowing concurrent collection of energy from the cells for an intended use.

More specifically, let's assume that the cell string 507 has similar electrical properties as cell string S described above with reference to FIG. 2, i.e. includes similar cells C1-C4 with similar corresponding I-V curves. Under conventional operation of the string, without associating it with power redistribution module 510, the electric current I_{E} through the string is equal to I_{S} (illustrated in FIG. 2), while cells C1, C3 and C4 operate below their respective MP points. The cells are constraint to provide an electric current limited by that of the string current I_{S} while being capable of generating greater output currents. To this end, the power redistribution module 510 operates as an energy exchanger, enabling the cells C1, C3 and C4 to operate at a power point (PP) closer to their MP points (i.e. optimal operation state of the cells) and to supply higher output currents. This enables the cells C1, C3 and C4 to produce electric currents greater than the electric current I_{E} through the string. The additional current produced by these cells is collected by and drained through the module 510 to compensate the current deficiency of the cell C2. Actually, the low current provided by cell C2 is automatically added with current drawn from the module 510. This enables cell C2 to generate current/energy at the string current value I_{S} and thus to raise the string's total output Power Point.

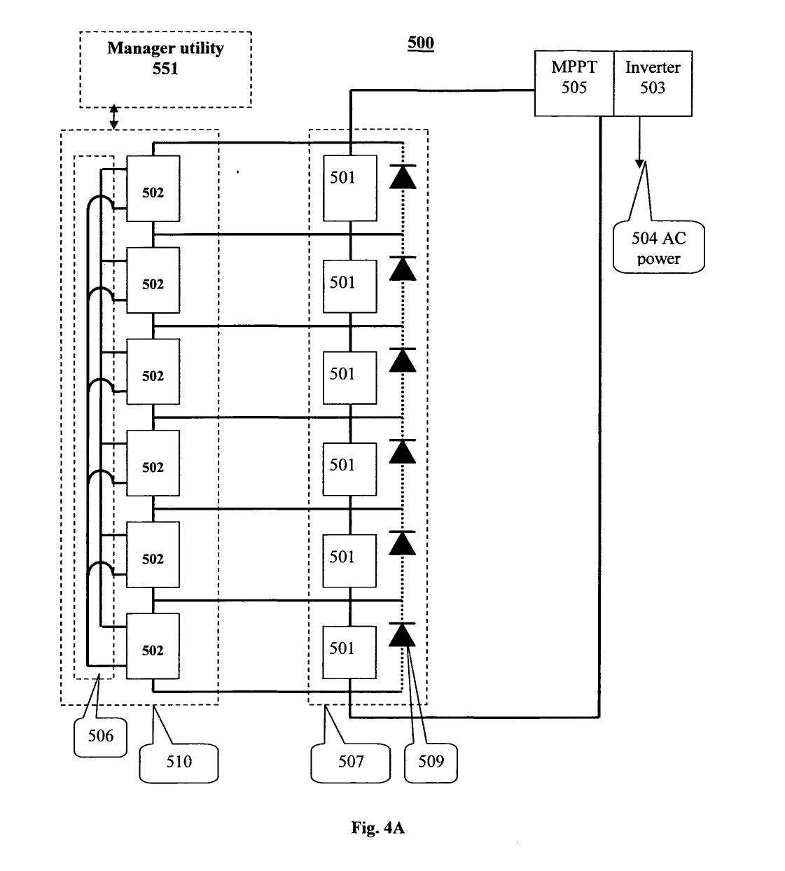

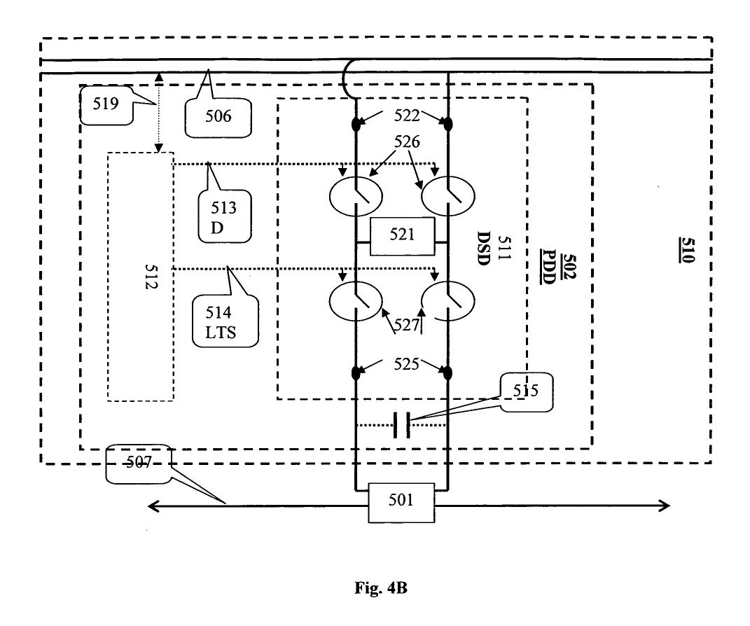

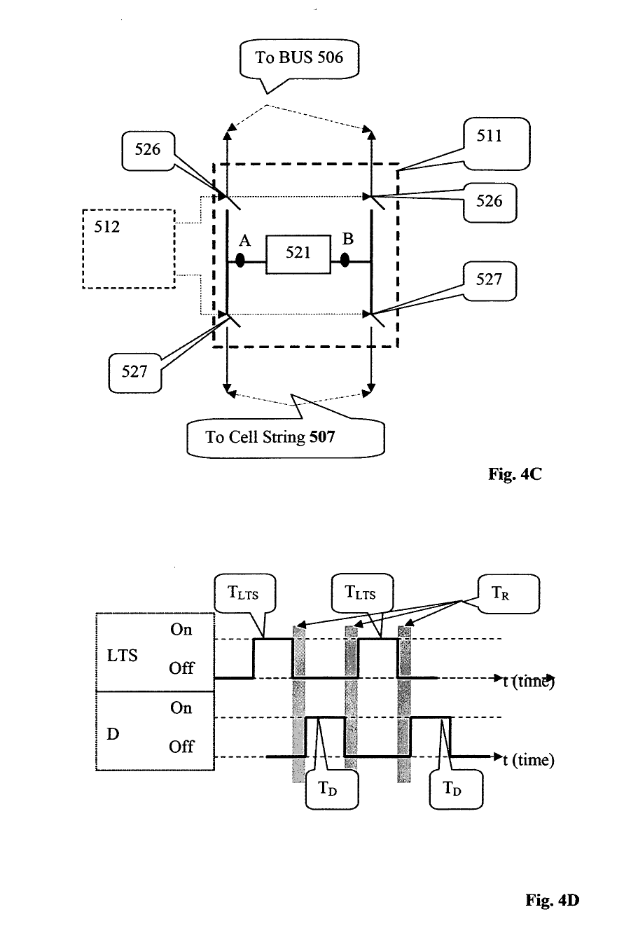

Turning now to FIGS. 4A to 4D there is illustrated more specifically an exemplary configuration of the energy harvesting system 500, namely the configurations of the power redistribution system 510 of the invention. To facilitate understanding, similar elements in all the examples are denoted with the same reference numerals.

As shown in FIG. 4A, the power redistribution module 510 includes a bus-connector 506 and a plurality (generally at least two) of electric coupling assemblies 502. The latter is configured and operable synchrony (e.g. by an appropriate manager utility 551 including inter alia a synchronizer utility/module) to provide selective electrical coupling between the bus-connector 506 and the cells (generally at least some of them, e.g. at least two) of the string 507 according to a predetermined time pattern. In the present not limiting example, the bus connector 506 is implemented by two electric conductors by which the coupling assemblies 502 are connected in parallel to each other. It should be understood that generally the manager utility used in the present invention is pre-programmable to control the operation of the switches connected to every cell/panel according to a predetermined time pattern, and preferably also synchronize these switches between themselves as shown in the present embodiment. Also, in this example, each coupling assembly 502 is associated with (connectable to) the respective one of the cells 501. It should however be noted that the same coupling assembly may be associated with more than one cell, e.g. a group of cells such as a serial string of cells. Multiple coupling assemblies 502 are arranged in parallel electrical connection between them via the bus-connector 506. Each coupling assembly 502 is associated with (e.g. electrically connected in parallel to) a corresponding one or more energy producing cells 501. In this example, the coupling assembly 502 operates dedicatedly to balance the operation of its corresponding cell 501. The coupling assembly 502 collects power produced by the respective cell 501 and transmits this power to the bus-connector 506, thereby causing self distribution of the power, collected by multiple coupling assemblies from multiple cells, back to the multiple cells via their respective coupling assemblies but in equalized manner.

When the cell 501 is over-performing (i.e. is capable of producing excess power, e.g. by operating at a power point different than that imposed by the current value along the string 507), the operation of the respective coupling assembly 502 enables the cell operation at a higher power point, due to extraction of excess energy from the cell by the coupling assembly. The excess power produced by the cell 501 is drained and accumulated by the coupling assembly 502. Alternatively, in case the cell 501 is under-performing, instead of being neutralized (as per the conventional approach), the respective coupling assembly 502 complements the required power for the under-performing cell, due to self distribution of said excess energy of the over-performing cell, and allows the under-performing cell to function and produce the energy it is capable of producing. Accordingly, the power is still being extracted from underperforming cells which otherwise would have been totally neutralized.

It should be understood that the energy generator (cell) 501 is referred to as under-performing when it is incapable of producing any power under the electrical constraints that are imposed thereon by the system 500. For example, in the context of the serial cell string 507, a cell 501 is under powered when it is incapable of producing current I_{E} above the current value Iₛ flowing along the string 507. In a case, it is capable of producing only current values below that flowing through the string, with the conventional approach, the cell is totally neutralized since it is not allowed to produce any power (e.g. zero voltage) and it is being bypassed by its corresponding bypass diode 509. It is common that some cells of a solar energy production system are under-performing for example due to a malfunctions or lack of light (shade/dirt) and high temperatures. On the contrary, an over-performing cell 501 is a cell 501 capable of producing excess power, e.g. by operating at a power point different than that imposed by the system 500. For example, in the context of the serial cell string 507, a cell 501 is over performing when it is being capable of producing output current I_{E} above the current value I_{S} flowing along the string 507.

It should thus be understood that the terms over performing cells and over powered cells and respectively the opposite terms under performing cells and under powered cells designate the relation between the maximal power that can be produced by a given cell under the given conditions at which it operates relative to the nominal 5. maximal power that can be obtained by other cells in the respective cell string. For example, if a cell is capable of producing more power than the average of the maximal powers (MPs) of cells in the string, this cell is over performing, and a cell is underperforming if it is not capable of producing the average maximal power (MP) of the cells in string.

The bus-connector 506 connects the coupling assemblies 502 between them and enables energy flow (e.g. equilibration) therebetween. This provides for transferring excess power produced by over-powered cells to the under-powered cells and by that to complement the deficiency in the power production of the under-powered cells. The efficiency of the power redistribution module 510 is high, because no voltage conversion, by a DC to DC convertor, is performed. For example, about 99.9% efficiency in harvesting energy is achieved in such a multi-cell system, while about 4% of the total energy is provided from over-performing to under-performing cells/panels (e.g. which are operating off average), i.e. 4% of energy handled with 97.5% efficiency results with 0.1% energy loss. Actually, the energy that is drained from the over-performing cell(s) by its/their corresponding coupling assembly/ies is substantially equal to the energy that is transferred by the bus-connector and provided to the underperforming cell(s) by its/their corresponding coupling assembly/ies. Accordingly, the operation of the redistribution module 510 results in the operation of the various cells each at its maximal, or near maximal, power point (PP).

When the system 500 is implemented as a solar energy system (e.g. the cells 501 being solar panels), coupling assembly 502 temporarily stores the excess power from the respective over-performing solar cell 501 (for example that located under direct sun light), when in the first operational mode of the coupling assembly 502. Then, in the second operational mode, the power stored in the coupling assemblies 502 is equalized via the bus-connector 506 connecting the coupling assemblies. In the next round, at the first operation mode the power is transferred from the respective coupling assemblies 502 to the underperforming solar cell(s) 501.

The serial string 507 is connected in parallel to the MPPT unit 505 that operates to select the maximal I/V operation point that produces the maximum DC power from the entire string 507. As noted above, in the absence of power redistribution module 510, the maximal operation point of the string is, generally, different from the maximum power point of all the individual cells 501 in said string 507. This is because, the serial connection architecture enforces all of the cells 501 to produce the same electrical current value along the string 507, while the individual cells 501 are generally associated with different I-V curves. However, with the use of power redistribution module 510 of the invention, each of the cells in the string can operate at a point close to the cell maximal power point, and thus the overall power of the total string 507 is higher than the overall power of the string in the absence of such power redistribution.

Considering an arrangement formed by a cell 501 and a coupling assembly 502, the MP point of such arrangement is generally higher than the operating point of the cell 501 itself (under the arrangement of a standard string 107A). As noted above, this is because, when connected with the coupling assembly 502, over-performing cells 501 are operating on a higher power point than under-performing solar cells 501 so that every cell 501 operates at an individual operation point near its own maximum power point.

Differently from voltage converters (such as DC-AC inverter and DC-DC converter), the efficiency E of the power redistribution module 510 of the present invention and the efficiency of the respective coupling assemblies 502 are substantially high. This is associated with the fact that the coupling assemblies do not boost up voltage and do not utilize (boost) DC to DC conversion which have relatively low efficiency (for example, to a buck DC to DC converter).

FIG. 4B illustrates, in more details, the configuration of the coupling assembly 502, in accordance with an embodiment of the invention. The coupling assembly illustrated in FIG. 4B is suitable for use in the power redistribution system/module 510 as illustrated in FIG. 4A. This coupling assembly 502 is illustrated as being a part of the power redistribution module 510 (e.g. connected to the bus-connector 506 of module 510) and is connected to a corresponding energy producing cell 501.

Generally, the electric coupling assembly 502 includes at least one coupler 511 associated with at least one cell 501, namely the coupler 511 is electrically coupled to the cell 501 and to the bus-connector 506. In this example, the coupler 511 includes a power storage unit 521 (implemented as capacitors in the present not-limiting example), and a switch assembly, which in the present example is formed by switches 526 and 527. This is also more specifically shown in FIG. 4C.

It should be noted that the invention can be implemented utilizing various types of electric energy storage elements. Specific non limiting examples of such elements include electric coils, piezoelectric devices and capacitors. For clarity, in the following description, the electric energy storage is considered mainly as including capacitors.

However, it is appreciated that persons skilled in the art would understand that any other suitable energy storage units can be used.

The power storage unit 521 is connected in parallel to the respective cell 501 and to the bus-connector 506 through the switching assembly 526 and 527, and operates to collect, store and distribute the electric power generated by the respective cell. The switching assembly is configured and operable (by the central control system, associated with the entire string or by a local controller 512, as shown in the present example) to successively operate in first and second operative modes. In the first operative mode, the switch assembly provides electrical connection between the power storage unit 521 and the respective cell 501, and in the second operative mode it provides connection between the power storage unit 521 and the bus-connector 506. By successive operation of the coupling assembly 502 in these two operation modes power generated by the cells is redistributed in between said cells.

More specifically, the power storage unit 521 is connected in parallel to the bus-connector 506 through a pair of electronic switches 526 (also referred to as bus-switches). The power storage unit 521 is also electrically connected in parallel to the cell/panel 501 through another pair of electronic switches 527 (cell-switches) of the switching assembly.

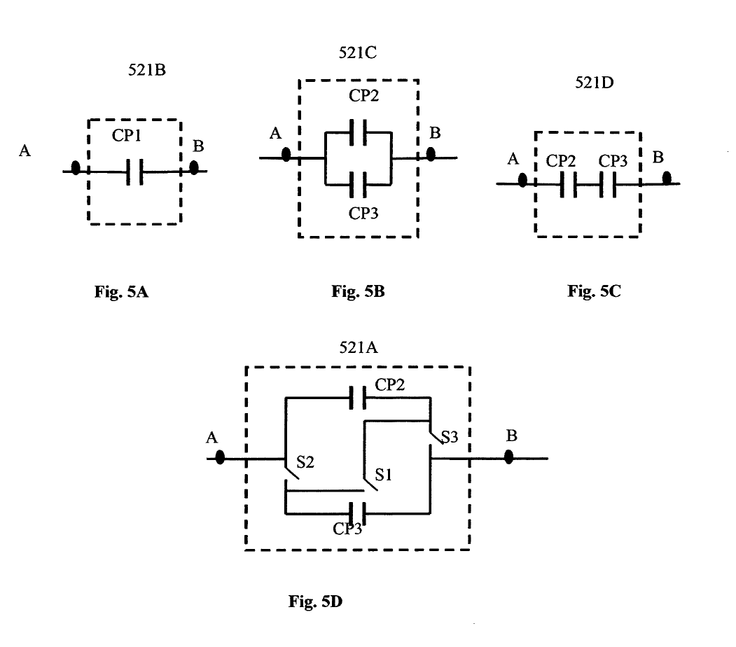

The power storage unit 521 described herein may be in the form of an arrangement of one or more capacitors which are adapted for storing electric energy. As will be further described below with reference to FIGS. 5A-5D, the power storage unit 521 can be of fixed capacitance, in which case the coupler 511 might be referred to as equal voltage coupler. Alternatively, as is also described below, variable capacitance can be used. This enables some control over the output voltages which are applied by the coupler to either one of the bus-connector 506 or to the cell 501 connected thereto. In the case of variable capacitance, the coupler is referred to as voltage multiplying coupler. In the example of FIGS. 4A-4D, the equal voltage coupler 511 is considered having certain fixed capacitance value C, however it should be noted that in general as well as in the system configuration of FIGS. 4A-4C, a voltage multiplying coupler can be used.

In general, the coupler 511 functions to decouple the operation properties of its corresponding cell 501 from the operation of the other energy generating cells in the system 500 and from the constraints on the cell's operation imposed by the cell string 507. As indicated above, the decoupling is obtained through two operation modes of the coupler 511 implemented via first and second operation modes of the coupler's switching assembly. In the first mode (the so-called Local To Storage (LTS) mode), the coupler 511 is exclusively connected in parallel to its corresponding cell (i.e. the switch assembly of the coupler is configured and operable for exclusive parallel connection of the respective storage unit 521 with the cell and is disconnected from the bus-connector). In this mode, the voltage (in the example of capacitor based storage) on the storage unit 521 is equalized to the voltage on the cell 501. In case the cell 501 is over-performing, the voltage on the coupler 511, prior to be connected exclusively to the cell, is lower than that of the cell 501. This results in draining excess energy produced by the cell/panel 501 and storage of this energy in the energy/power reservoir (capacitor) 521. In case the cell 501 is under-performing, the voltage on the storage unit 521, prior to be connected exclusively to the cell, is higher than that of the cell, and the operation of the coupler 511 provides (downloads) energy from the energy/power reservoir 521 to the cell to complement the energy deficiency of the cell 501.

In the second mode of operation (the so-called distribution (D) mode), the coupler 511 is exclusively connected in parallel to the bus-connector 506. In this mode, the energy stored in the power storage units 521 is redistributed. Actually, if all couplers 511 and storage units 521 are similar, the energy is equalized between the storage units 521 of all the couplers 511 which are associated with and connected by the bus-connector 506 and which are operating at the second mode.

In this example, during the first mode of operation of the coupler 511, the bus-switches 526 are disconnected (open or OFF state), while the cell switches 527 are connected (closed or ON state). Accordingly, during this mode of operation, the voltage of power storage unit 521 equilibrates with the cell's output voltage. While voltage equilibration is taking place, capacitor 521 is charged or discharged in accordance with the voltage differences between the capacitor 521 and the cell 501. During the second mode of operation, the bus-switches 526 are in ON state and the cell switches 527 are in OFF state. When in this mode of operation, the power storage units 521 are electrically connected to each other by the bus-connector 506. The energy stored in the couplers 511 is redistributed between the couplers to equalize the energy in each coupler to the performance of a virtual average cell of the string 507.

Typically, as can be seen in FIG. 2, an over-performing cell C1 which is forced to operate with a fixed output current value (I_{S}) outputs higher voltage than that of an under-performing cell C3 operating with the same output current value (I_{S}). Accordingly, utilizing the capacitance equation CV=Q where C is the capacitance of a capacitor (constituting a power storage unit 521), V is the steady state voltage on the capacitor, and Q is the steady state charge accumulated on the capacitor. During the first mode of the coupler (switching assembly) operation, the charge and voltage on capacitor 521 associated with an over-performing cell would be higher than the charge and voltage on similar capacitor 521 associated with an under-performing cell.

During the second operation mode of the coupler (switching assembly), the power storage unit (capacitor) is connected in parallel to the bus-connector 506, and the voltages (and charges in case similar capacitance is considered) equilibrate (approaching their steady state) among all capacitors 521 of the couplers which are connected to the bus-connector and operate at the second mode. Consequently, the voltages of the capacitors of different couplers associated with over-performing cells are reduced and the voltages of the capacitors associated with under-performing cells are increased. Hence, when turning back to the first mode of operation, the capacitors of the couplers associated with the over-performing cells have lower voltages than their corresponding cells and are thus recharged and drain current (power) from the respective cells. On the contrary, the capacitors of the couplers associated with the under-performing cells have higher voltages than their corresponding cells and thus they are discharged to the cell-string and complement the current deficiency of the respective cells.

During the first and second operation modes of the coupler 511 (switching assembly), its power storage unit 521 is connected exclusively to either one of the respective cell 501 and bus-connector 506. In the first mode, both cell switches 527 are closed while both bus switches 526 are open, and vice versa in the second mode. During a shift of the coupler 511 between its first and second modes, both of the cell switches 527 and both of the bus switches 526 are switched to an open state to prevent the bus-connector 506 from shortcutting the cell string 507. It should be noted that all the switches 526 and 527 might be implemented by one or more, dual mode, exclusive OR electronic switches.

In some embodiments of the invention, the power coupling assembly 502 includes a coupler's local synchronizer 512 which operates to synchronize the switches 526 and 527 for switching the coupler in between its first and second modes of operation. According to some other embodiments, the power coupling assembly 502 is associated with an external synchronizer. Such external synchronizer may be associated with the operation of multiple power coupling assemblies.

The coupler local synchronizer 512 is in communication with the cell- and BUS-switches (527, 526), for example through wired or wireless communication. The operation of the cell-switches and the BUS-switches (527, 526) is controlled by two output signals: Local To Storage (LTS) 514 and Distribute (D) 513 signals respectively. These output signals operate the switches to traverse the coupler in between its first (LTS) and second (D) modes of operation. During the time period when the LTS signal 514 is ON and the D signal 513 is OFF, the coupler 511 operates in its first (LTS) mode equalizing its voltage with the output voltage of its respective cell 501. During the time period when LTS signal 514 is OFF and D signal 513 is ON, the coupler 511 operates in its second (D) mode distributing power with other power coupling assemblies via the bus-connector 506. When both the LTS and D signals 514, 513 are ON or OFF the capacitor 521 of coupler 511 is totally disconnected.

Reference is made to FIG. 4D illustrating in a self explanatory manner the operation of the coupler's local synchronizer 512. The synchronizer 512 operates to alternately set signals LTS and D in their ON and OFF states. There is no overlap between the time slots of the ON states of the LTS and D signals to prevent the bus-connector 506 from shortcutting the cell string or portion thereof. During the LTS time slots T_{LTS}, LTS signal is ON and D signal is OFF, and the coupler 511 is operating in its first (LTS) mode. During the distribution time slots T_{D}, LTS signal is OFF and D signal is ON and the coupler is operating in its second (D) mode. The durations of time slots T_{LTS} and T_{D} are not necessarily equal and may be determined in accordance with the time that is required for substantial voltage equilibration of the capacitor with the cell during the first operation mode and in accordance with the time required for substantial charge distribution in between different couplers during the second mode. These durations may be, in turn, dependent on the capacitance of the power storage units 521, characteristics of the electrical wires along the system, and the characteristic voltages in the system.

The time slots T_{LTS} and T_{D} alternate in a cyclical manner with as short as possible transition periods T_{R} between them. During the time slots T_{R} (transition periods) both the LTS and D signals are OFF. This may be required, since practically a certain time is needed for switches 526 and 527 to switch between their ON and OFF states. The operation of the coupler's local synchronizer 512 is synchronized with other such synchronizers of other coupling assemblies 502 of the same power redistribution module (i.e. that are connected with the same bus-connector 506). Such synchronizing configuration ensures that during the second mode of the coupler operation, power is redistributed with all other couplers associated with all other cells along the string.

The synchronizer configuration can be implemented utilizing any known suitable synchronization technique. For example, the synchronizers 512 may be connected to different coupling assemblies 502 by wired or wireless communication. Such communication might be used to schedule, synchronously, the periods (initiation and termination) of the second mode of operation (D mode) of the corresponding couplers (511). During these periods, the power stored in all the couplers 511 is redistributed (e.g. equalized).

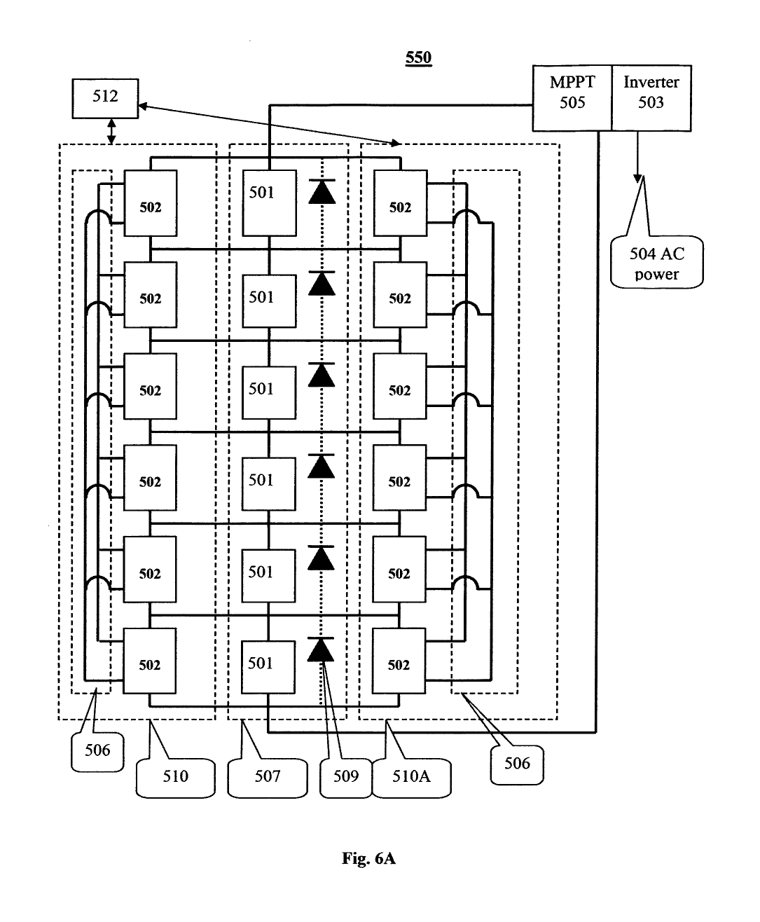

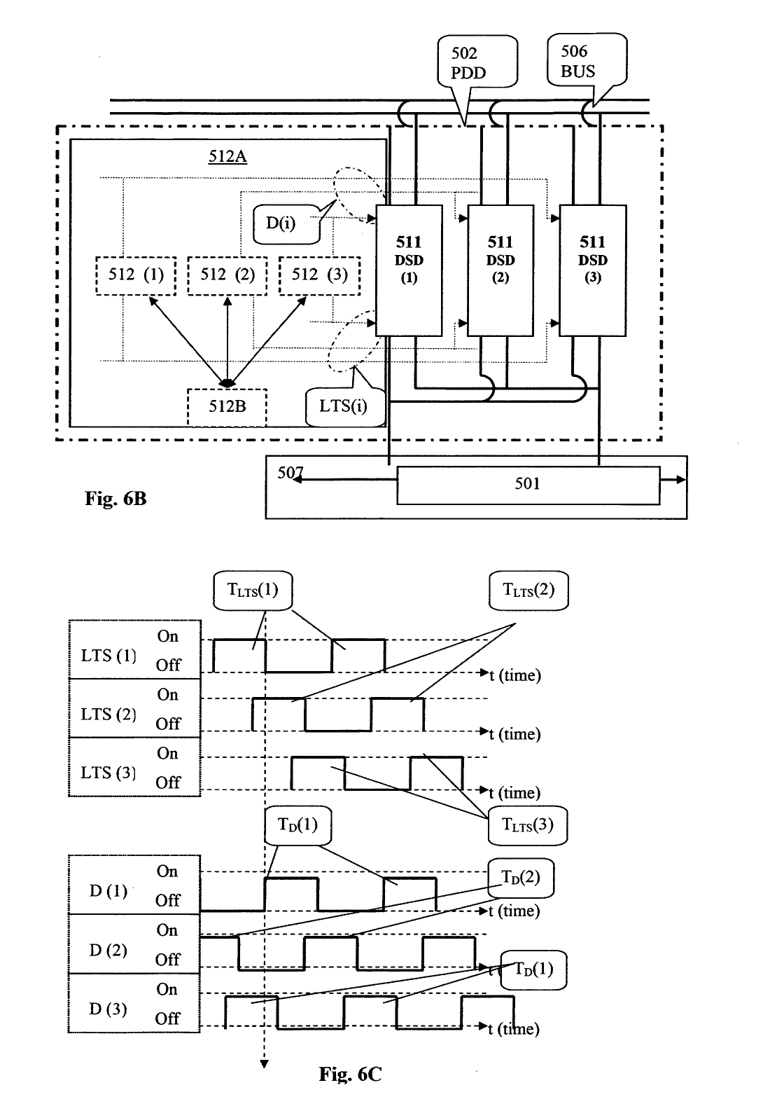

Alternatively, in some cases it is preferable to utilize unsynchronized operation of the synchronizer 512 in which the transitions between the coupler's first (LTS) mode and second (D) mode are un-correlated with the operation of other couplers. As will be further described below with reference to FIGS. 6B and 6C, in some configurations of the system, the coupling assembly 502 includes multiple couplers (generally at least two) to continuously redistribute power with other coupling assemblies (502). In such configurations, the operation of the couplers of different coupling assemblies need not to be synchronized between them since at any given moment power is redistributed among all the cells, because all the coupling assemblies constantly employ at least one coupler operating in its second (D) mode.

Reference is made to FIG. 5A to 5D illustrating schematically the configuration of the power storage unit 521 suitable for use in the above-described coupler.

As noted above, the energy/power storage may be implemented as an electric charge storage unit utilizing one or more electric capacitors for providing certain effective capacitance in between points A and B. In the present examples, the energy/power storage 521 is implemented as a charge reservoir comprising a single capacitor (FIG. 5A), a pair of serially connected capacitors (FIG. 5C) and a pair of capacitors (FIG. 5B) which are connected in parallel with each other. These configurations for energy/power storage 521 (charge storage in this case) present certain fixed capacitance between the points A and B which can be used in a coupler of the equal voltage type as noted above.

FIG. 5A illustrates the energy/power storage 521 implemented by a single capacitor CP1 of certain capacitance C. The amount of electric energy that is stored in such capacitor under certain voltage V is given by CV²/2. FIG. 5B illustrates parallel configuration PC of the energy power storage unit 521 implemented by two capacitors CP2 and CP3, in this example of similar capacitance C. In this configuration, the capacitors CP2 and CP3 are connected in parallel to each other, and thus their equivalent capacitance (i.e. between points A and B) is 2C. FIG. 5C illustrates serial configuration SC of the energy power storage unit 521 implemented by two serially connected capacitors CP2 and CP3. In this example, each of the capacitors has capacitance C, and the equivalent capacitance (between points A and B) is C/2. It should be understood that many other configurations involving multiple capacitors in series and/or parallel connections can be used for implementing the energy/power storage unit 521 in the form of electric charge storage.

FIG. 5D illustrates an implementation of the energy/power storage unit 521 capable of performing voltage multiplying and having dynamic variable effective capacitance, providing a Voltage Multiplying type electric storage. In this example, the storage unit 521 includes two capacitors CP2 and CP3, each having capacitance C, and capacitors are electrically interconnected by a set of electric switches S1, S2 and S3. Setting the switches S1, S2 and S3 to different ON and OFF states shifts the connection between the capacitors and alters the effective capacitance between the output points A and B of the storage unit.

More specifically, in accordance with the present examples, in one operational state of the storage unit 521, switch S1 is closed and switches S2 and S3 are open. In this state, the capacitors CP2 and CP3 are serially interconnected (configuration SC shown in FIG. 5C) having effective capacitance of C/2. In the other state of the storage unit 521, switch S1 is open and the switches S2 and S3 are closed. In this state, the capacitors CP2 and CP3 are interconnected in parallel to each other (configuration PC shown in FIG. 5B) and the effective capacitance of the unit 521 is 2C.

Switching the voltage multiplying type storage unit 521 in between its different configurations (PC, SC), while not varying the amount of electric energy stored thereon, substantially varies the output voltage of unit 521 (in between points A and B). Actually, switching the voltage multiplying type storage unit 521 between PC and SC configurations presented in FIGS. 5B and 5C respectively provides multiplications with factors 2 or ½ in the output voltage of the storage unit 521 relative to the output voltage of each of the individual capacitors. A total multiplication factor of 4 is obtained in between the output voltages at the respective PC and SC configurations.

It should be understood that the above example of voltage multiplying type storage unit enables only two multiplication factors (of 2 or ½) over the output voltage from the storage unit. However, utilizing more than two capacitors and multiple switches enabling various electrical interconnections between the capacitors may provide multiple discrete effective capacitance values of the storage unit and respectively a number of voltage multiplication factors.

In accordance with the above, and turning back to FIG. 4B, a coupler 511 unit utilizing the voltage multiplying type storage unit 521 actually presents highly efficient DC to DC voltage conversion associated with a discrete set of multiplication values associating the voltages at terminals 522 and 525 (e.g. bus and cell ports) of the coupler. The use of multiplying couplers enables to provide higher or lower voltages at the generator side.

The use of voltage multiplying type storage units provides highly efficient power optimization from the power/energy generating cells also when the output voltages of the over-performing cells are lower than the output voltages of under-performing cells. For example, this may be the case where the I-V curves of the cells are much different, such that the maximal power point MP of the over-performing cells has lower voltage (but higher current) than that of the under-performing cells. In the coupler's configuration exemplified in FIG. 4B (e.g. where equal voltage type storage 521 is used), the direction of power pumping between the respective cell and the bus-connector depends on the potential differences (and voltage drop) between the respective cells connected simultaneously to the bus-connector. Higher potential at one cell means that power is drained there from by the coupler, while lower voltage at one other cell causes power voltage to be pumped towards that cell.

In some cases, over-performing energy producing cells may provide lower voltages at their respective MPs than the voltages provided at the MPs corresponding to under-performing energy producing cells. For example, a cell string may include cells operating with I-V properties similar to IV₂ and IV₄ of cells C2 and C4 shown in FIG. 2. These I-V properties correspond to the operation of solar cells under shaded and over-temperature conditions, respectively. In this case, the cells having I-V properties curves similar to IV₄ are over-performing with respect to the cells associated with I-V properties IV₂, because their maximal power points MP₄ are associated with greater output power than the output power associated with MP₂ of the cells having I-V curves similar to IV₂. In such cases, utilizing power optimizing system of the invention, e.g. of FIGS. 4A-4C, with couplers of the equal voltage type would not enable pumping power from over-performing cells to the under-performing cells. This is because equal voltage couplers enable to pump power in one direction, from high voltage source to low voltage source. In this example, however, when pumping energy from the over-performing cells (associated with I-V curve IV₄) to the under-performing cells (I-V curve IV₂), the operation power points of the over-performing cells are pushed towards their respective MP₄ resulting in a decrease in the output voltage from the over-performing cell below the output voltage of the under-performing cells, and consequently power is not transferred from the over-performing to the under-performing cells.

Power optimization from a solar string that includes over-performing energy producing cells operating with low output voltages and under-performing cells operating with higher output voltages is possible by utilizing a system similar to that illustrated in FIG. 4A-4D with the couplers 511 utilizing voltage multiplying type storage unit similar to that exemplified further below with reference to FIG. 5D.

Referring back to FIG. 4B and considering the coupler 511 being voltage multiplying type coupler, in order to get to specific maximal power point per cell, different voltages are required at the local terminal 525 (cell side) and at the distribution terminal 522 (bus side) of the coupler 511. For downloading power to an under-performing cell operating at high voltage, during the first LTS mode of the coupler operation the power storage unit is set to high voltage output, e.g. serial configuration SC according to FIG. 5C. Accordingly, the output voltage at the local cell-side terminals 525, connected with the under-performing cell, is high (multiplied). In the second (distribution) mode of the coupler 511, the storage unit 521 is set to low voltage configuration, e.g. parallel configuration PC according to FIG. 5B. In this example, up-boosting of the bus-connector 506 voltage is carried out with the under-performing cells to force power pumping thereto.

Forcing power drainage from over-performing cells having low output voltage is achieved with the opposite procedure. At the first LTS mode of the coupler operation, its storage unit (voltage multiplying type storage unit) is set to low voltage output, e.g. PC configuration of FIG. 5B. The output voltage at the local terminals 525, connected with the under-performing cell, is low (e.g. lower than the bus-connector voltage). In the second (distribution) mode of the coupler 511, the storage unit 521 is set to high voltage configuration, e.g. SC configuration of FIG. 5C.

The PC and SC configurations only exemplify low and high voltage states illustrated with reference to the storage unit 521 in FIG. 5D. It should be understood that the same principles illustrated in FIG. 5D can be implemented with multiple voltage states (not only dichotomic high/low states), and the storage unit can be implemented with any number of sets of switches and capacitors to enable any set of voltage multiplications required. Alternatively or additionally, a DC to DC converter or any other voltage conversion technique can be used in association with the coupler 511 (e.g. with the electric power storage 521) to apply different voltages to the bus-connector 506 and the cell 501. When using storage units that include a number of voltage states associated with high voltage multiplication factors, it might be preferable to use cascaded sets of switches and capacitors groups, each constituting lower voltage multiplication factors such that exponential voltage multiplication value is obtained.

As described above, the coupler 511 operates exclusively in either one of its first or second modes in a cyclic manner. However, power optimization of the cell 501, associated with a respective coupler 511, is performed only during the first mode of operation of the respective coupler 511. Several solutions described below are proposed to enable continuous power optimization on the cell 501.

Turning back to FIG. 4B, the coupling assembly 502 may optionally include a local power storage element (local capacitor) 515 connected in parallel to the respective cell 501. This local capacitor 515 spreads the supply/draining of power, which is performed during the first operation mode, such that it lasts also during the second mode of the coupler's operation.

During the first mode of the coupler 511 operation, the local storage 515 is connected in parallel with the power storage unit 521 of coupler 511 and the respective cell 501, equilibrating voltages therewith. Accordingly, during the first mode of the coupler 511 operation, the voltage on local storage 515 approaches some average value associated with the output voltages of a virtual average cell of the string 507. During the second mode of the coupler operation, the voltage on the local capacitor 515 equilibrates with the output voltage of cell 501. Therefore, during the second mode of operation, the local storage 515 compensates for the over/under-performance of the cell by draining/supplying energy to the cell. In case the cell 501 is under-performing (in which case its output voltage may be below said average value), then local capacitor 515 downloads power to the string (e.g. current is flowing from the local capacitor 515 to add on the output current of the cell 501 connected thereto. In case the cell 501 is over-performing (in which case its output voltage is typically above said average value), then local capacitor 515 drains power from its respective cell 501, for example. the excess current produced by the cell 501 above the current flowing through the cell string charges the local capacitor 515. In this sense, the local storage 515 serves to extend the first mode operation of the coupler 511 also to the periods in which the coupler is in its second mode. During these periods, the local capacitor 515 is drifting from its power point towards the power point of its respective cell (solar panel) 501. Power is being uploaded from the cell 501 to the local capacitor 515 in case of over-performing cell 501, or downloaded from the local capacitor 515 to the cell 501 in case of under-performing cell.

Power production mismatch between solar panels are typically small, but under shading conditions they may grow to 50% difference between over-performing and under-performing solar panels and even more. In this case, the excess current flow in the bus-connector may grow up to 10 ampere or higher. The use of local capacitor solution as described above for providing continuous power collection optimization will significantly increase (e.g. double) the current flow because it uses only half the time for the second mode of operation of the coupler. Although when utilizing multiple unsynchronized couplers, on average, the current through the bus-connector can be equalized.

In the absence of local capacitor 515, during the time when the coupler 511 is in its second mode of operation, it is inactive with respect to the cell string 507 to which it is connected (i.e. it is not operated at this time to optimize the power generation from the cells 501). Hence, in order to enable continuous power optimization for a cell string 507, at least two couplers 511 are preferably used such that at any given time at least one coupler 511 is in its first mode of operation.

Reference is made to FIGS. 6A and 6B illustrating two embodiments of the present invention configured for providing continuous power optimization to the cells 501 of the cell string 507. A common feature of both embodiments of FIGS. 6A and 6B is that each of the power generating cells 501, which is to be optimized, is associated with, i.e. connected in parallel to, at least two couplers 511. Continuous power optimization is achieved by configuring the at least two couplers 511 such that at any given time at least one couplers 511 operates in its first (LTS) mode of operation.

In FIG. 6A, electric energy production system 550 is illustrated. The system 550 includes similar elements as those of the system described with reference to FIG. 4A. Namely, the system 550 includes cell string 507 and power redistribution module 510. In the present example of FIG. 6A, the system 550 includes one additional power redistribution module 510A and a synchronizer module 551 configured for synchronizing the operation of coupling assemblies 502 of modules 510 and 510A.

Modules 510 and 510A are associated with the same cell string 507 and are configured and operable to enhance the energy production from the string 507 by optimizing the power points at which the individual cells operate, in the manner described above. In the present example, each cell 501 is associated with two coupling assemblies 502 corresponding to different power redistribution modules 510 and 510A respectively. The two coupling assemblies 502 are synchronized by the synchronizer 551 such that their couplers alternately operate in the first and second modes, while at any given time at least one of their couplers is in its first mode of operation. Actually, in the present example, modules 510 and 510A are synchronized (by synchronizer 551) such that couplers 511 of all coupling assemblies 502 associated with the same module (510 or 510A) operate simultaneously at the same operation mode (e.g. either in the first (LTS) or second (D) mode). Accordingly, in the following description of this embodiment, the power redistribution modules themselves are referred to as having respective first (LTS) and second (D) modes of operations.

The two power redistribution modules 510 and 510A operate together in complementary manner to continuously optimize the power generation from the cell string 507. This is achieved by configuring the time durations T_{LTS} and T_{D} of the first and second mode of the module's operation and the time T_{R} of the switching (transition) between the modes to be such that T_{LTS}≧T_{D}+2T_{R}. In this case, it would be sufficient that at least one power redistribution module operates at the first mode thereby enabling continuous power optimization of the string.

It should be noted that for clarity, only a single cell-string 507 and two (similar) corresponding modules 510 and 510A are presented in FIG. 6A. However, in general, more than two such power redistribution modules 510 may be used. This is in order to enable continuous power optimization of string 507. More specifically, the minimal number of modules required in the current configuration in order to enable continuous power optimization of string 507 is determined as the upper integer value of [(T_{D}+2T_{R})/T_{LTS}], i.e. by the relative required duration of the first and second modes of operation and the time of transition between these modes.

The configuration described with reference to FIG. 6A requires synchronization between different coupling assemblies of different power redistribution modules which are associated with the same cell 501. Accordingly, synchronizer 551 is used to synchronize the coupling assemblies 502 and in preferred configuration also to synchronize a unified operation of the coupling assemblies 502 of each of different power redistribution modules (510 and 510A). Also, the use of multiple modules is associated with multiple bus-connectors 506 corresponding to the multiple modules.

FIG. 6B illustrates schematically another possible configuration of a coupling assembly 502 suitable for use with the electric energy harvesting system of the present invention. The coupling assembly 502 illustrated in this figure is a part of power redistribution module 510 (similar to that of FIG. 4A, and not shown in its entirety in the present figure) and is connected to BUS-connector 506 of said module to which additional, preferably similar, coupling assemblies are connected. The configuration of coupling assembly 502 described with reference to this figure is designed to provide continuous power optimization (100% of the time) to the cell 501 associated therewith. Also, this configuration obviates the above two requirements, namely for utilizing multiple power redistribution modules (multiple BUS-connectors) and for synchronizing between coupling assemblies of different modules.

According to this embodiment, the coupling assembly 502 includes at least two couplers 511 and a local synchronizer 512A. Actually, synchronizer 512A functions to synchronize the mode of operation of each of the couplers 511 of the respective coupling assembly 502 which are connected thereto in accordance with a certain predetermined synchronization scheme/time pattern.

In the present example, the coupling assembly 502 includes three similar couplers 511(1), 511(2) and 511(3), controlled by synchronizer 512A. Although the functionality of synchronizer 512A can be implemented in various ways, for clarity of the description of its functional operation it is described as implemented utilizing synchronizer 512B and several coupler synchronizers, generally 512(i), similar to synchronizer 512 which was already described with reference to FIG. 4B. In the present example, synchronizer 512A includes three coupler synchronizers 512(1) to 512(3) associated respectively with three couplers 511(1) to 511(3) and adapted for synchronizing the operation modes thereof. Similarly to the synchronizer 512 of FIG. 4B, also in this example, each of the coupler synchronizers 512(i) utilizes signals D(i) and LTS(i) to control the operation mode of its respective coupler 511(i). Signal LTS(i) ON and signal D(i) OFF corresponding to the first LTS mode of 511(i), and Signal LTS(i) OFF and signal D(i) ON corresponding to the second (distribution) mode of 511(i). Synchronizer 512B is in communication with the coupler synchronizers 512(1) to 512(3) for synchronizing their operation. Preferably, the operation of synchronizers 512(1) to 512(3) is synchronized such that at any time at least one of the couplers 511(i) is in its first (LTS) mode.

FIG. 6C exemplifies graphically the synchronization of the operations of couplers 511(1) to 511(3) as implemented by synchronizer 512B in the example of FIG. 6B. During the time periods T_{LTS}(i) the operation mode of the respective coupler 511(i) corresponds to LTS (first) mode in which coupler 511(i) equalizes its power storage with the cell 501. Accordingly, during these time periods the respective signal LTS(i) is ON and signal D(i) is OFF. During the time periods D(i) the operation mode of the respective coupler 511(i) is Distribution (second) mode during which said respective coupler 511(i) equalizes its power with other coupling assemblies 502 via the BUS-connector 506. As noted above, in case the signals LTS(i) and D(i) of the same coupler 511(i) are both ON or both OFF the respective coupler 511(i) is totally disconnected. The synchronizer 512B operates to synchronize the operation of the couplers 511(1) to 511(3) of the same coupling assembly. Typically, as seen in the FIG. 6C, the operation of the couplers 511(1) to 511(3) is synchronized by scheduling the LTS time periods T_{LTS}(i), (i being 1, 2 and 3), during which signals LTS(i) and D(i) of the corresponding coupler 511(i) are ON and OFF respectively, in consecutive cyclical manner with respect to the operations of the different couplers 511(i). The scheduling is performed such that at least one coupler is in LTS mode at any time of operation. Typically, there is an overlap between the first mode of operation of the couplers, i.e. one coupler enters the LTS mode of operation and only then another coupler exists its LTS mode of operation. This is done so that there is at least one coupler associated with the cell 501 which is in the LTS mode continuously.

It should be noted that in case each coupler is capable of being in its first (LTS) operation mode more than half of the time, it is sufficient to utilize two couplers 512(1)-512(2) in the coupling assembly 502 in order to continuously provide the cell 501 with a coupler operating in its LTS mode. However, taking in to account that the switching time between the first and second operation modes of the couplers 511 is greater than zero, at least three couplers 511 per the coupling assembly 502 are required for providing continuous operation at the LTS mode. Such that at any time, each coupling assembly 502 associated with at least one coupler is connected to the BUS-connector (second operation mode) and at least one coupler is connected to the cell 501 (first operation mode). Hence, carrying out the timing sequence exemplified in FIG. 6C (synchronously or not) on all coupling assemblies of the power distribution module 510 (which are connected to BUS-connector 506) guarantees that at all times each coupling assembly has at least one coupler 511(i) connected to the BUS-connector 506 (i.e. operating in its second mode), and thus ensures constant power exchange between the coupling assemblies of the power redistribution module 510. During overlapping time periods at which two neighboring couplers (e.g. 511(1) and 511(2)) of the same coupling assembly 502 operate simultaneously in the second mode, power is transferred (e.g. voltage equalized) also among the neighboring coupling assemblies.

As noted above, energy/power redistribution occurred in between all the couplers which are in their second operating mode, i.e. connected to the BUS-connector. A steady state at which most of the energy power transfer between different couplers has been completed (e.g. at which only negligible power remains non-redistributed between different couplers) is typically reached after certain steady state time duration T_{S}. Steady state time duration T_{S} is typically associated with certain characteristics of the power redistribution module such as the resistance of the BUS-connector 506, the capacitance of the couplers used, and the voltage differences involved. Also preferably, at each cycle of the coupler operation, the time duration T_{D} of the second mode (Distribution) is of the order of the steady-state time duration T_{S} to enable efficient power redistribution during the second mode.

In some embodiments of the system, similar couplers are used, e.g. having the same electrical characteristics for example the same capacitance, and accordingly power and voltage equilibration between the couplers is obtained at steady state. Hence, at every cycle of operation, during the second mode operation of the coupler, it equalizes the voltage to the common voltage of the BUS-connector 506. Thus, utilizing three couplers 511(1) to 511(3), the voltage over the cell 501 equalizes towards the common voltage of the BUS-connector 506 three times every cycle of the LTS(i) signals. Typical power generation systems (e.g. solar systems), such as that of FIG. 1, include high voltage strings which may include large numbers of energy generating cells. Typical strings create high DC voltage such as 400 or 600 or even 1000 volt DC from end to end. When utilizing the power redistribution module of the invention (510 illustrated in FIG. 4) with such high voltage strings, during the operation cycle of the coupling assemblies this high voltage is set in its entirety on down to two switches (e.g. two of the switches 526 and/or 527 in FIG. 4A-4B) of one or more coupling assemblies, i.e. shortcutting the cell string 507 is prevented by only two serially connected switches of one or more coupling assemblies (the number and identity of the switches depending on the respective operation mode of the coupling assembly at each time). Such circuits preventing shortcuts are kept open by 2 serial switches each in different coupling assembly along the bus-connector. Switches that can bear such voltage are relatively slow and expansive.

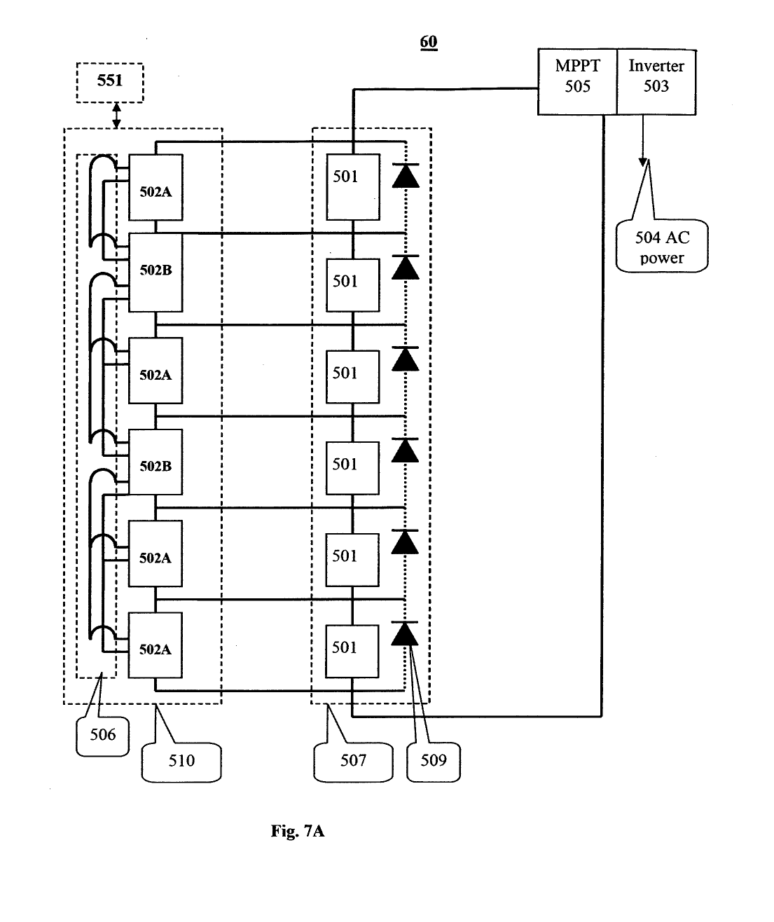

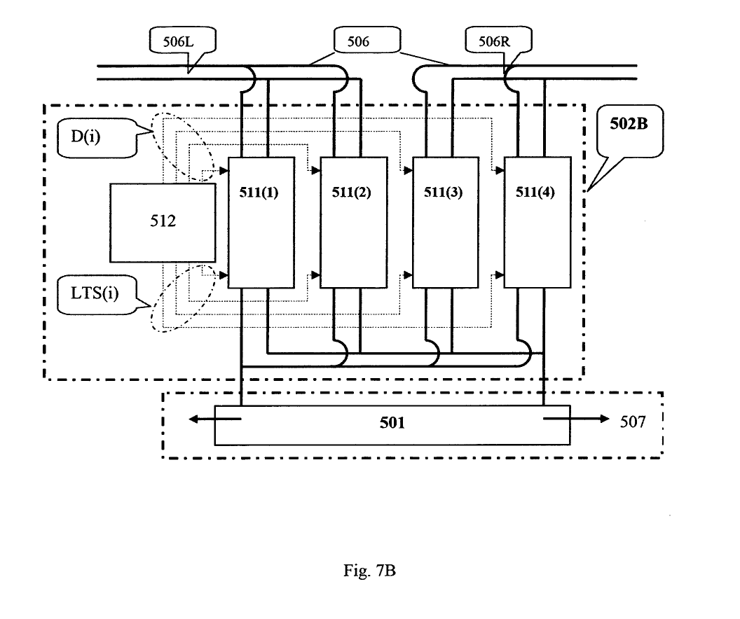

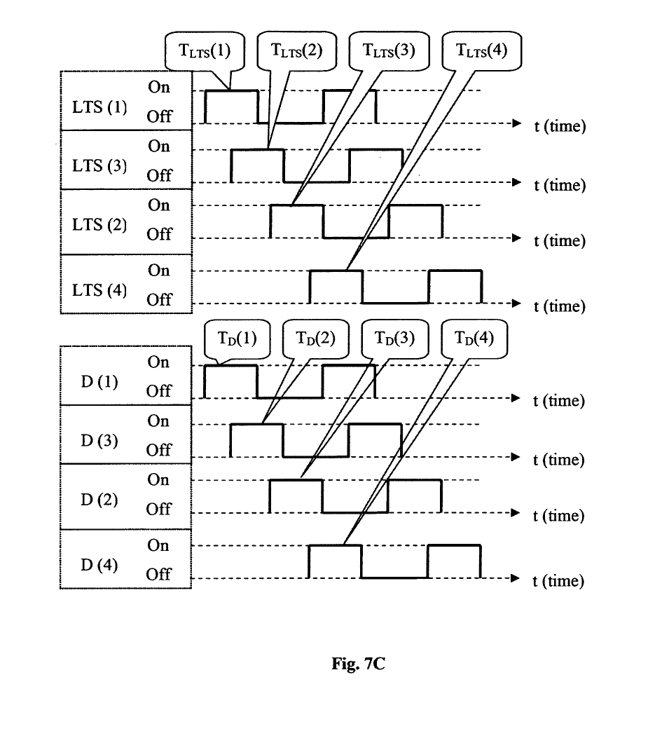

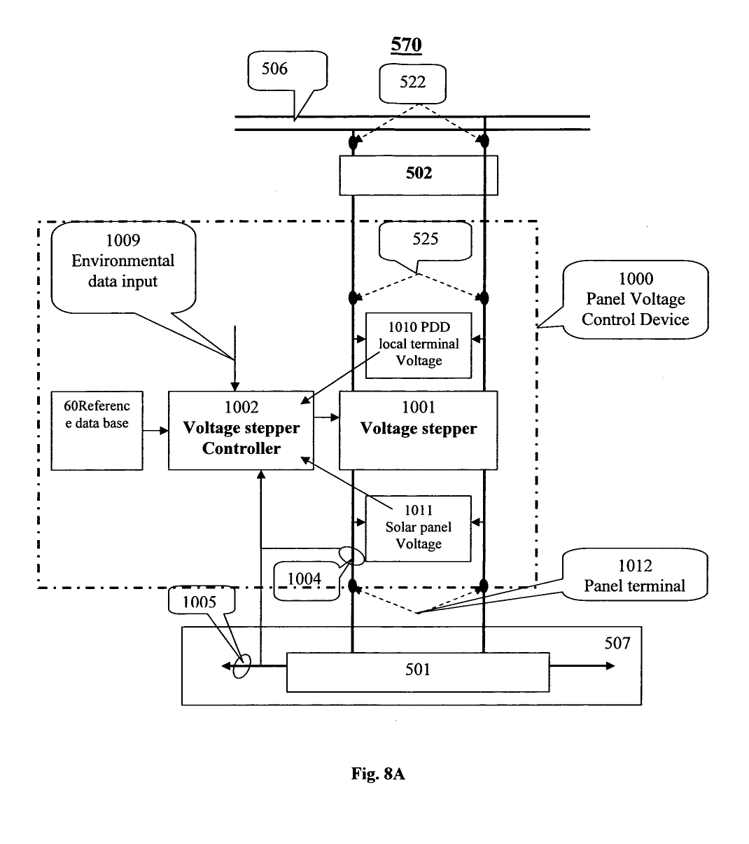

Reference is now made to FIGS. 7A to 7C exemplifying another embodiment of the invention, where the power redistribution module/system is designed to handle long string with high voltage end to end using standard 100 volt fast FET switches. As shown in FIG. 7A, the power redistribution module 510 includes a bus-connector 506 having multiple separate connectors, each connector being associated with a group of cells (preferably consecutive serially connected cells) from the multi-cell string 507. Also, module 510 includes coupling assemblies of two types 502A and 502B, where coupling assemblies of type 502A are configured similar to the above-described coupling assemblies 502, namely each associated with a single bus-connector element, while the coupling assemblies of type 502B are associated with more than one bus-connector element. Each of the bus-connector 506 elements is implemented by two electric conductors to which the respective coupling assemblies (502A and/or 502B) are connected in parallel. It should be noted that with such configuration the use of coupling assemblies of type 502A may be eliminated and all the coupling assemblies in the power redistribution module may be coupling assemblies of type 502B.

FIG. 7B shows more specifically the configuration and operation of the coupling assembly of type 502B. The coupling assembly 502B is equipped with 4 couplers 511 and a local synchronizer 512. The four couplers 511(i) are associated with two bus-connector elements 506L and 506R of the bus-connector 506 such that couplers 511(1) and 511(2) are associated with bus-connector element 506L, and couplers 511(3) and 511(4) are associated with bus-connector element 506R. The synchronizer 512 can send two output signals groups LTS(i) and D(i). During the time period T_{LTS}(i) when the LTS(i) signal is ON and D(i) is OFF the respective coupler 511(i) equalizes its power storage with the solar cell 501. During the time period T_{D(i)} when LTS(i) signal is OFF and D(i) signal is ON the coupler 511 equalizes its power with the other coupling assemblies associated with the respective bus-connector element. When both LTS(i) and D(i) signals are ON or OFF the respective coupler is totally disconnected. The synchronizer 512 schedules signals D(1), D(2) ON periods and signals LTS(1), LTS(2) OFF periods in a raw with minimum transient time and no overlapping time periods between them in a cyclical manner so that their mutual ON time is maximum and more than 50% of the overall time; and similarly schedules signals D(3), D(4) ON periods and signals LTS(3), LTS(4) OFF periods. Similar time sequences are applied to all the coupling assemblies 502B of the power redistribution module. This arrangement provides that whenever coupler 511 is connected to any of the bus connector elements, the module will have another coupler connected at the other end of the same bus-connector element for at least part of the time, so said couplers will equalize their voltage. Such timing sequence guarantees the following: cell 501 is connected to at least one coupler 511 at all times to provide continues excess current drainage in case of over performing solar cells or missing current supply in case of underperforming solar cells; during the overlap time periods the neighboring couplers of the same coupling assembly will equalize voltage among them; voltage equalization among all the couplers in the coupling assembly will equalize voltage between the bus-connector elements associated with the same coupling assembly 502B; consequently the voltage over all of the bus connectors 506 will equalize towards a common voltage; and the voltage over the cell 501 will equalize towards the common voltage of the bus-connectors 506 four times every cycle of the LTS(i) signals. Such architecture disconnects the coupler from any other coupler which is not associated with the same bus connector element, and therefore the maximum voltage handled by the coupling assembly is limited to the total output voltage of the cells associated with the same bus-connector elements. This technique enables long cell strings to work with standard FET switches although the voltage produced by the string may be higher than the maximal load of the switches.

In a typical solar system such as that of FIG. 1, most solar panels/cells will have quite similar electrical characteristics. Environmental conditions such as different temperature or lighting of the cell may differ between the cells and affect the voltage of the solar cells. The present invention enables every solar cell to work in its optimal current regardless to the other cells' current, but at the same time equalizes the voltage over all solar cells with which the power redistribution is associated.

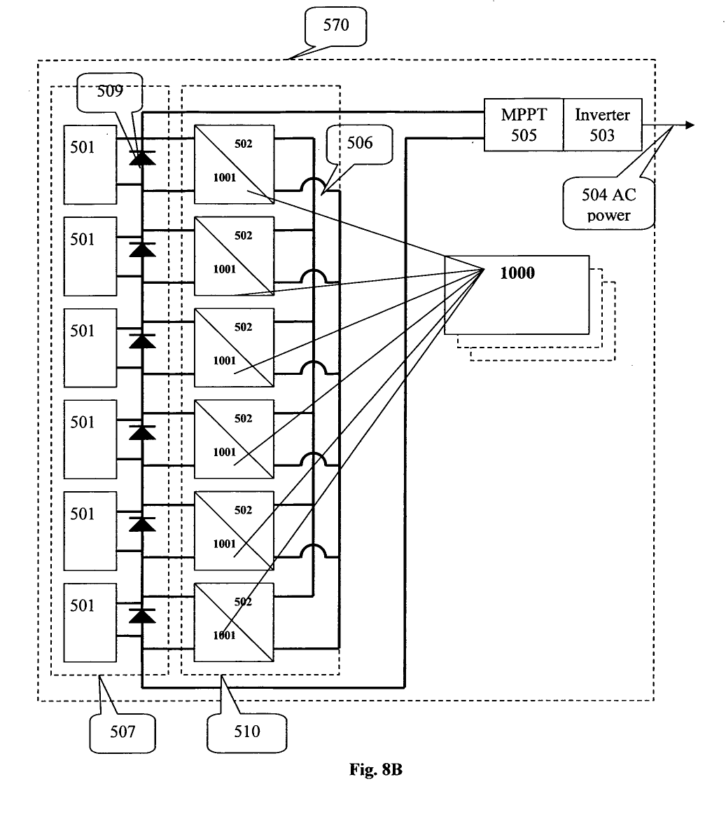

Reference is made to FIG. 8A, illustrating an energy generation system 570 (not shown in its entirety) utilizing the principles of the present invention and designed to control the voltage difference between the energy generator side of the coupler and the actual generator connection. More specifically, in this system, a voltage gap is created between the local side of a coupler 511 in the coupling assembly 502 and the respective solar cell output that should be optimized to its particular MPP voltage.

In the present example, similarly to the above described examples, a coupler assembly 502 is associated with a BUS-connector 506 on the one end, and is connected via local terminals 525 to a voltage control module 1000. The voltage control module 1000 is connected at its other port to a cell/panel 501 which power is to be optimized. The voltage control module 1000 is configured and operable for modifying the output voltage of the coupler assembly 502 that is applied to the cell 501. Accordingly, the voltage control module 1000 is equipped with an appropriate voltage stepper 1001 electrically interconnected in between the cell 501 and the local terminals 525 of the coupler assembly 502. The voltage stepper 1001 may be implemented for example as a bidirectional buck DC to DC converter or as a duty cycle device with a capacitor and 2 switches.

The voltage control module 1000 is adapted for controlling the value of the voltage that is applied to cell 501 by its respective coupler assemblies 502 and allows for controlling the voltage of the cell 501 independently from the voltage of the bus-connector 506. This enables accurate adjustment of the cells' operation power point (i.e. pushing each individual cell towards its MPP).

To this end, the voltage control module 1000 includes one or more sensors, a voltage stepper 1001 and a voltage stepper controller 1002 connected thereto. The sensor(s) is/are adapted to provide data indicative of at least one of the following: the operational state of the individual cell(s) 501, the operational state of the string (507), and the environmental conditions. The voltage stepper controller 1002 is configured and operable to process the sensor(s) output data and to determine and adjust the voltage that is to be applied to the cell 501. Adjustment of the voltage to the cell 501 is performed by utilizing the voltage stepper 1001 associated therewith.

The voltage stepper controller 1002 is optionally associated with reference database (not shown here). Current sensor 1004 is used to measure the electrical current through terminal 1012 of the voltage stepper 1001. This electrical current is indicative of the current that is “pushed to” or “drained from” the cell 501 by its respective coupler assembly 502. Additional current sensor 1005 is used to measure the electric current along the cell string 507. A voltmeter 1010 is used to measure the voltage at the local terminal 525 of the coupler assembly 502, and additional voltmeter 1011 is used to measure the voltage of the cell 501 (i.e. at the cell terminal 1012). Also, environmental data, such as sunlight intensity and temperature, is read by using corresponding sensors (not specifically shown). The voltage stepper controller 1002 utilizes the environmental data 1009 and the reference data from the database to calculate an expected voltage across the cell (at terminal 1012). This expected voltage is compared with the actual voltage measured by the voltmeter 1011 at the terminal 1012 to determine whether the cell is operating at its expected MPP or requires a correction in its operation point.

If the cell requires a correction, then the voltage stepper controller 1002 calculates new operational parameters for the voltage stepper 1001 based on the measurements of the current values measured by sensor 1004 and 1005 and the voltage measured at the terminal 1011 of the coupler assembly 502. Accordingly, the cell's 501 voltage (which is measured by sensor 1011) is set to its required value as calculated by the controller 1002 while the output voltage from the coupler assembly (the voltage at the local terminal 525) does not change.

The voltage on the local terminal 525 of the coupler assembly 502 may be adjusted up or down (multiplied) in case the coupler assembly and couplers are of a voltage multiplying type, similar to those described with reference to FIG. 5D. In this case, the voltage stepper 1001 may be a voltage reduction device, such as high efficiency bidirectional buck programmable DC to DC converter or a simple current choker.

Furthermore, it should be understood that in different implementations of the system of the invention, the voltage stepper 1001 may be electrically connected to respective components of the system at different locations. For example, voltage steppers may be used to control the voltages at the distribution terminal 522 (bus side) of the coupler assembly 502 and/or at the local terminal 525 such as in the present example. Also, the voltage steppers may be integrated within the couplers assembly, in which case voltage couplers such as illustrated in FIG. 5D may also serve as voltage steppers.

FIG. 8B illustrates the configuration of the energy generation system 570 (shown partially in FIG. 8A). System 570 is configured similar to the system 500 described above with reference to FIG. 4A. However, in addition to the elements of system 500, the system 570 of the present example is equipped with a voltage control devices 1000 such as those illustrated in FIG. 8A. The voltage steppers 1001 of the voltage control devices 1000 are respectively electrically interconnected in parallel to the coupler assemblies 502 and to the cells 501, as described in FIG. 8A, in between every cell/panel 501 and its corresponding coupler assembly 502. Accordingly, the system 570 is capable of efficient power redistribution between the cells similar to the efficiency of system 500. Moreover, utilizing the capabilities of the voltage control devices 1000, system 570 is capable of maintaining each and every one of the cells 501 at its own MPP.

It should be understood that many elements of the voltage control devices 1000 may or may not be common with other such voltage control devices. For example, each voltage control device 1000 may be implemented as an independent unit that includes its own sensors and database. Such a unit might be entirely implemented as an integrated structure and can be accommodated on the solar panels/cells or battery cells. Alternatively, a single database can be used with common environmental sensors. Also, multiple voltage stepper controllers (not specifically shown) might be implemented as a single controller module (computing unit) or by multiple separate modules.

The present invention also provides a solution for another problem associated with the conventional approach for multi-cell power generation systems. Turing back to

FIG. 1, where there is illustrated a “large” energy generation system 100, namely a system including multiple cell strings architecture. When such energy generation system 100 of multiple cell strings (107a and 107b) is operated, the different strings 107a and 107b generally have different output voltages (e.g. due to different environmental conditions or different cell parameters). Since the strings are connected in parallel to an MMPT 105 and to inverter 103, blocking diodes 106 are used to prevent back current from flowing through the lower voltage string.

Actually, considering the string 107a as having high (relatively) output voltage and string 107b as having low (lower) output voltage, blocking diode 106a at the end of the higher voltage string (107a) operates with reverse bias voltage thereon, such that the output voltage from the cell string 107a is reduced (drops) to the lower voltage of string 107b. Accordingly, blocking diode 106a consumes the extra power that is produced by the string 107a. The extra power consumed by the diode (wasted power) is associated with the voltage drop (i.e. the difference in the output voltage of the strings) multiplied by the string current.

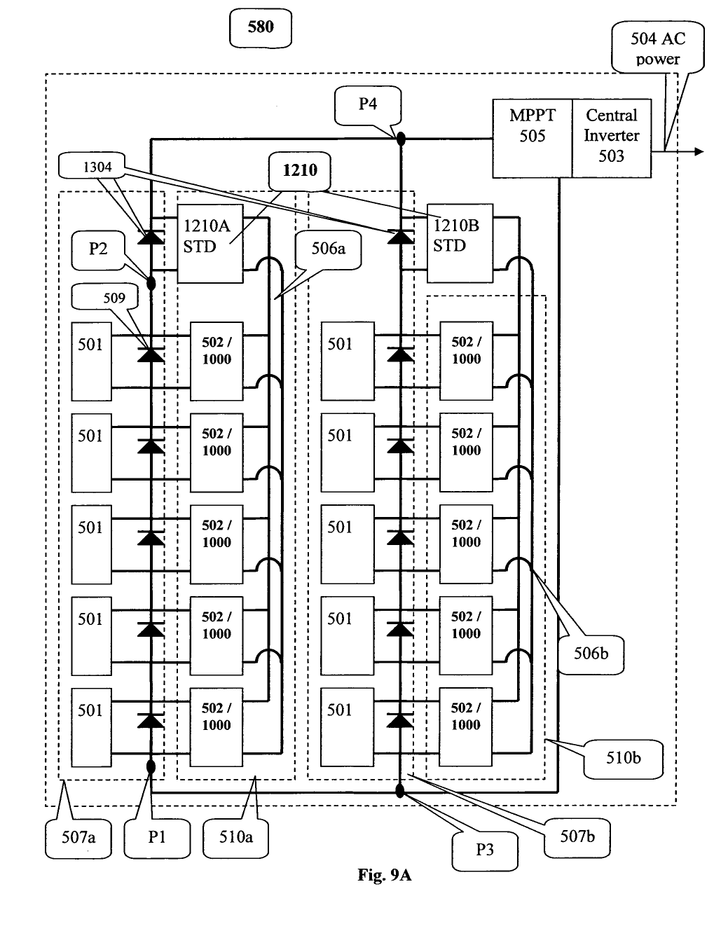

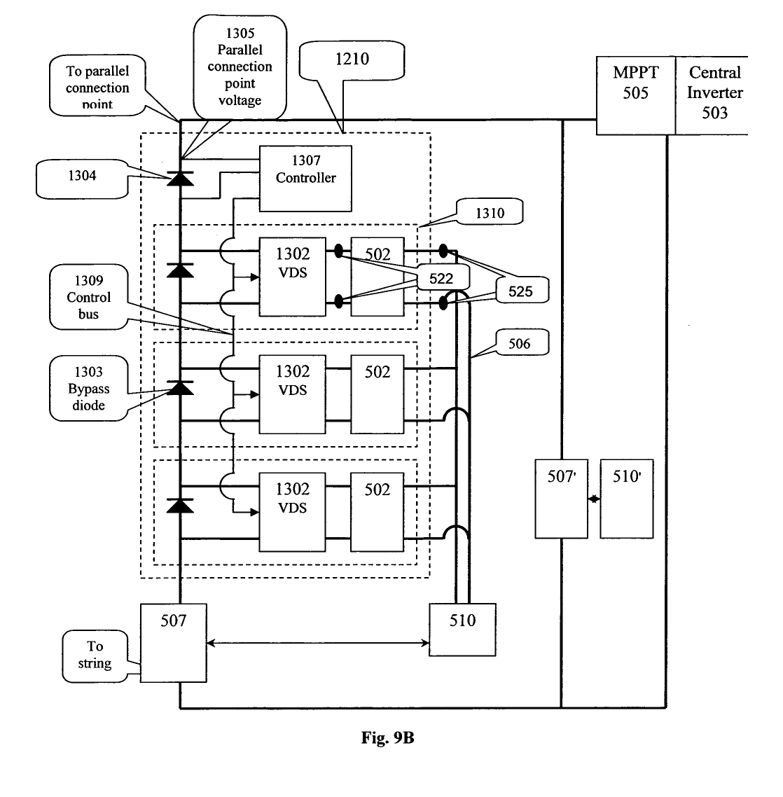

FIG. 9A illustrates an energy/power generation system 580 configured with multiple strings architecture and including two strings 507a and 507b. Each of the strings is associated respectively with power redistribution module 510 according to the present invention. In this example, similar to the examples of FIGS. 8A and 8B, the power redistribution module 510 includes Voltage Control Devices 1000 associated with the cells 501 of the string. Accordingly, the strings 507a and 507b operate, in a similar manner as the cell string of FIGS. 8A and 8B, such that each of the cells operates near its maximal power point.

In the present example, the power redistribution module 510a, 510b of each of the strings (507a and 507b) is equipped with a respective string termination device (1210A, 1210B). Each string termination device is configured as a voltage source which is connected in series to its respective string. In the present example, the string termination devices are connected in parallel to the respective string's blocking diode 1304. It should be noted however, that in general, the use of blocking diodes can be obviated when the string termination devices are used.

The string termination devices 1210A, 1210B are configured for complementing (rising) the output voltage of their respective strings 507a, 507b by operating as a controllable voltage source. Actually, the string termination device 1210A raises the voltage of its respective string 507a up to a certain higher voltage. The latter is typically determined as the highest output voltage produced by other strings, 507b in this example, connected in parallel with said string 507A; or is a predefined fixed voltage to which all the strings are to be adjusted.

During its operation, the string termination device (e.g. 1210A) utilizes the power redistribution module 510a, which is associated respectively with the string 507a, as a power supply. To this end, the string termination device 1210A is connected in parallel to the BUS connector 506a of the power redistribution module 510a. In order to adjust the output voltages of its respective string in order to match said certain desired high voltage (a so-called “target” voltage), the string termination devices 1210A utilizes power from the BUS connector 506a.

The voltage difference between the target voltage and the string's (507A) output voltage (i.e. between the points P1 and P2) is complemented by the string termination device. In this connection, the string termination device may operate in accordance with a first operation scheme, to determine the magnitude of the voltage gap (e.g. in advance to its operation in bridging this gap) and/or in accordance with a second operation scheme, according to which, during the operation of the string termination device, the voltage gap is closed without the string termination device acquiring any prior knowledge relating to the magnitude of this voltage gap/difference.

In accordance with the first operation scheme, the voltage difference is determined by defining the target voltage which is to be applied to the MPPT 505 (e.g. which is to be applied in between the points P2 and P4). Then, the output voltage of the string 507a is determined (e.g. by measuring the voltage between points P1 and P2). The voltage gap, being the difference between these two voltages, is then complemented by the string termination device 1210A.

However, this (first) operation scheme requires preliminary determination of the voltage target to enable consequent preceding determination of the voltage gap that is to be compensated for (bridged). The target voltage can be an independent fixed voltage value (i.e. independent from the actual voltages of the strings) that is expected to be higher than any reasonable voltage that any of the strings can produce. This fixed voltage value can be “coded” or “hard coded” within the string termination device 1210 or it can be obtained by measurements. For example, a high voltage value (serving as the target voltage value) can be maintained between points P3, P4 by an external module (e.g. the voltage on the MPPT). Then, this voltage can be measured by each of the respective string termination devices to determine their target voltage.

The second operation scheme enables each of the individual string termination devices to operate without obtaining a target voltage value, thus obviating a need for the individual string termination devices to determine data indicative of the voltage at the MPPT or the voltages of the other strings in the batch. This is based on the understanding that when the string's 507a output voltage V_{S} (between P1 and P2) is higher than said certain output voltage Vₘₚₚₜ from other strings (between P3 and P4), then the string is an over performing string and will have to waste its extra energy on its respective blocking diode 1304. Accordingly, the voltage over the blocking diode V_{d} becomes negative V_{d}<0 (i.e. reversed bias voltage) such that Vₛ+V_{d}≅Vₘₚₚₜ. This is different in case the string's output voltage is below the output voltage Vₘₚₚₜ from the other strings. In this case, the string is an underperforming string and the reverse bias voltage on the diode is minimal (e.g. V_{d}≧0). Accordingly, by measuring the voltage over its respective string blocking diode, the string termination device can determine whether its corresponding string is under-performing or over-performing relative to the other strings in the batch and to operate accordingly for raising or decreasing the string's output voltage. Hence, in accordance with the second operation scheme of the string termination device, it is associated or equipped with voltmeter sensor for measuring the voltage V_{d} over the blocking diode 1304 of its respective string. As long as the measured voltage V_{d} on the diode is greater or equal to zero (or when it is above a certain threshold below zero—to prevent consequential “infinite” voltage raising by the multiple string termination devices), then the string is considered as underperforming and the string termination device increases the voltage supply to the string. While the voltage supply to the string is increased beyond the voltage Vₘₚₚₜ, then the voltage over the diode drops below zero and the string becomes over performing. In this point, the string termination device stops increasing the voltage, and the total voltage output from the string and its string termination device is maintained at the desired value.

The string termination devices 1210, which are connected to the BUS connectors of their respective power redistribution module 510, utilize/drain power from BUS connectors 506 of over-performing strings to increase the output voltages of the underperforming strings. This minimizes the voltage difference between the underperforming (lower voltage) and over-performing strings (higher voltage). This way the output voltages (at the parallel connection points of the strings P3, P4) of the string terminators of all the strings are equalized to the voltage of the highest voltage string. Accordingly, this feature of the invention may be used to create equal voltage strings, by providing one point of reference being the voltage on the parallel connection point P4. This reference voltage is higher than any other string voltage in a segment of parallel connected strings. By equalizing the strings' voltages, the voltage over the blocking diodes 1304 of the different strings is minimized down to the diodes saturation voltages. Accordingly, since the energy consumed by a diode is generally a linear function of the diode voltage, it is therefore minimized as well. Typically, as long as the voltage gap between the reference point P4 and the string voltage is above zero, no current will flow through the diode.

FIG. 9B exemplifies in more details the configuration of a string termination device 1210 (similar to string termination devices 1210A and 1210B of FIG. 9A). Generally, the string termination device 1210 is coupled with a power redistribution module 510 of its respective string 507. The power redistribution module 510, which may be of similar configuration as described above (e.g. FIGS. 4A-4D, 6A, 6B), serves as a power source for the string termination device 1210 and enables the string termination device to supply voltage to its respective string 507.

The string termination device 1210 is equipped with a string termination controller 1307 and one or more voltage compensation units 1310, typically one or two such voltage compensation 1310 units are used.

The string termination controller 1307 is associated with one or more sensors (voltmeters) which are adapted to measure the voltage gap between the string's output voltage and the reference voltage (e.g. at points P2, P4 of FIG. 9A). Then, utilizing the to measurements from the sensors, the string termination controller 1307 determines the deficiency in the string's output voltage (i.e. a certain value by which the string voltage should be raised in order to cover the voltage gap).

The string termination controller 1307 is also in communication with (i.e. is connected to) voltage compensation unit(s) 1310. The string termination unit is utilized for controlling the voltage that is supplied to the string by the compensation unit(s) 1310.

Each voltage compensation unit 1310 serves as a voltage source in the string and is electrically connected in series with the string. Also the voltage compensation unit 1310 is electrically connected in parallel with the BUS connector 506 of its respective string's power redistribution module 510.

The voltage compensation unit 1310 includes a coupling assembly 502 and a voltage down stepper (VDS) 1302. The coupling assembly 502, which may be similar to the above described coupling assemblies, is electrically connected to the BUS connector 506 through its distribution terminals 522. Also, the coupling assembly 502 is also connected to the input terminals of the voltage down stepper 1302 by terminals 525. The voltage down stepper 1302 is constructed and operated similar to the above described voltage controller 1000.

The voltage down stepper 1302 is in turn electrically connected in series to the string 507 through its output terminals such that any output voltage from the voltage down Stepper 1302 is added to the string's 507 output voltage thereby raising the total voltage of the string 507. Optionally, the voltage down Stepper 1302 is further connected in parallel, by its output terminals, with a bypass diode 1303 which serves for safety.

In accordance with the operation of the coupling assembly described above, each coupling assembly 502 equalizes or multiplies the voltage on its local terminal 525 with the voltage of the BUS side terminal 522. Accordingly, in the absence of a voltage down stepper 1302, i.e. in case the voltage compensation unit is configured with a coupling assembly 502 that is directly electrically connected in series (via its local terminals 525) to the string 507, the output voltage of the string would be raised by the value of the BUS voltage or any integer multiplication of that voltage per each voltage compensation unit connected to the string. However, in order to enable adjustment of the voltage by which the voltage of the string is raised, a voltage stepper is used for voltage manipulation and interconnection in between the string and the coupler assembly.

It is preferable to utilize voltage down steppers as their energetic efficiency is typically high. Moreover, while utilizing voltage down steppers, the upper limit by which the string's voltage can be raised is bounded by the nominal voltage of the BUS connector multiplied by the number of voltage compensation units 1310 used in the string termination device and further multiplied by a multiplication factor of the couplers 502. The nominal voltage of the BUS connector is typically about the average output voltage from the cells 501 of the string in case equal voltage couplers are used in the power redistribution modules 510. Hence, voltage down steppers can be used in cases where sufficient number of voltage compensation units 1310 are included in the string termination device 1210, such that the standard voltage deviation between the strings can be compensated for without up-stepping the voltages. The voltage down steppers 1302 can be implemented using any suitable known device capable of reducing a voltage from any given voltage to any other desired lower voltage with high energy efficiency, such as high efficiency Buck DC to DC converter or current choker.

Thus, the voltage down stepper 1302 receives as an input the voltage on the BUS connector 506 and transfers a part of this voltage to the string 507, in accordance with the command/instructions received from the string termination controller 1307. In case the output voltage of the voltage down stepper 1302 becomes higher than the saturation voltage of the bypass diode 1303 (such saturation voltage is typically −0.4 to −0.7 volts), the electric current flow through the diode 1303 stops and the voltage down stepper 1302 takes the load.

Consequently, the current through the string termination device 1210 is equal to the string current at all times. All of the voltages down steppers 1302 provide output voltage values in between 0 and certain maximum voltage which corresponds to the nominal voltage of the BUS connector 506.

As indicated above, in some cases, the target/reference output voltage, towards which the voltage of each of the strings is to be boosted, is determined in accordance with the highest output voltage among the strings. The string termination controller 1307 is configured for determining the target voltage by measuring the voltage gap between points P2 and P4 in FIG. 9A. However, in some cases, the target/reference voltage is set as the voltage parallel connection points (P3 and P4 of FIG. 9A). In these cases the voltage in between these points can be controlled by a central inverter.

Thus, the present invention solves the naturally existing problem in energy production systems which utilize multiple energy generators. The problem to be solved is associated with the fact that the generators may have different performance. Those skilled in the art will readily appreciate that various modifications and changes can be applied to the embodiments of the invention as hereinbefore described without departing from its scope in and by the appended claims.

1. An electronic system for energy collection from a plurality of electrically connected energy generators each having a respective current-voltage characteristic, said electronic system comprising a power redistribution unit electrically connected to said plurality of electrically connected energy generators, the power redistribution unit comprising a bus-connector and at least two electric coupling assemblies electrically connectable to the bus-connector, each of the electric coupling assemblies being associated with one or more of the energy generators and being configured and controllably operable to provide selective electrical coupling between the bus-connector and said at least two of the energy generators thereby enabling redistribution of power in between said at least two energy generators and optimizing energy collection therefrom.

2. The system of claim 1, wherein said electric coupling assembly comprises at least two couplers, the coupler comprising:
an energy storage unit for storing electrical energy configured for electrical connection with the respective energy generator; and
a switch assembly successively operable in first and second operative modes, the switch assembly when in the first operative mode providing electrical connection of the corresponding energy storage unit and the respective energy generator, and when in the second operative mode providing electrical connection between the energy storage unit and the bus-connector thereby performing the redistribution of power in between said at least two of the energy generators.

3. The system of claim 2, wherein said electric power redistribution unit is configured to provide parallel connection between at least some of the storage units via the bus-connector, thereby enabling the redistribution of power in between the storage units while electrically connected to the bus.

4. The system of claim 1, wherein said electric coupling assemblies are operable according to a predetermined time pattern.

5. The system of claim 4, wherein the time pattern is selected such that during the system operation there always exists at least one coupling assembly in electrical connection to the respective one or more of the energy generators.

6. The system of claim 4, wherein the time pattern is selected such that during the system operation there always exists at least one coupling assembly in electrical connection to the bus-connector.

7. The system of claim 2, wherein the storage unit comprises at least one charge storage device.

8. The system of claim 2, wherein the switch assembly is configured and operable in accordance with said predetermined time pattern to provide exclusive parallel connection of the respective storage unit with either the corresponding energy generator or with the bus-connector.

9. The system of claim 2, wherein said electric coupling assembly is configured such that at least two of said couplers are associated with the common one of the energy generators, such that, during the system operation, at least one of said at least two couplers is in an operational condition thereof corresponding to the first operative mode of the switching assembly.

10. The system of claim 2, wherein said electric coupling assembly is configured such that at least two of said couplers are associated with the common one of the energy generators, such that, during the system operation, at least one of said at least two couplers is in an operational condition thereof corresponding to the second operative mode of the switching assembly.

11. The system of claim 2, comprising a manger utility preprogrammed with said predetermined time pattern and being configured and operable to synchronize the successive operation of the switch assembly in the first and second modes.

12. The system of claim 11, wherein said manager utility comprises a plurality of synchronizers, each connected to one or more of the couplers associated with the respective energy generator.

13. The system of claim 2, wherein the power storage unit comprises at least two charge storage devices, and the switch assembly which is configured for selectively implementing either parallel or serial connection between said at least two charge storage devices, thereby enabling control of an electric potential on said power storage unit.

14. The system of claim 1, wherein said power redistribution unit is configured and operable to provide a condition that a predetermined electrical parameter of each energy generator together with its storage unit approaches an average value of said parameter of all of said at least two energy generators.

15. The system of claim 14, wherein said electrical parameter is at least one of electric power, electric current and voltage.

16. The system of claim 14, wherein said electrical parameter is an electric current.

17. The system of claim 16, wherein the power storage unit comprises at least two capacitors, and is selectively shiftable between different electrical conditions corresponding to different electrical connections between said at least two capacitors, resulting in different effective capacitance of said power storage unit, thereby providing variation of output voltage of the power storage unit, providing for redistributing the electric current between the energy generators.

18. The system according to claim 17, wherein the power storage unit comprises an additional switching assembly configured and operable to implement said selective shifting of said power storage unit between its different electrical conditions characterized by different capacitance respectively.

19. The system according to claim 1, comprising at least one termination device associated with a respective array of the serially connected energy generators, and connected to the bus-connector of the power redistribution unit, said termination device being configured and operable to utilize power from said bus-connector for controllably raising output voltage of said array of the energy generators.

20. The system according to claim 19, comprising at least one termination controller associated with said at least one termination device respectively, the termination controller is configured and operable for determining a target voltage to which the output voltage of said array of the energy generators is to be raised.

21-24. (canceled)
